(19) United States
(12) Patent Application Publication
(10) Pub. No.: US 2025/0376167 A1
(43) Pub. Date: Dec. 11, 2025

(54) VEHICLE CONTROL DEVICE, VEHICLE CONTROL PROGRAM, AND VEHICLE CONTROL METHOD

(71) Applicants: DENSO CORPORATION, Kariya-city (JP); J-QuAD DYNAMICS Inc., Tokyo (JP)

(72) Inventors: Kazuki IZUMI, Kariya-city (JP); Yuuki OZAWA, Tokyo (JP); Ryu KAMBARA, Tokyo (JP); Koji SHIBATA, Tokyo (JP); Yuka SATRE, Tokyo (JP); Yuki YAMAMOTO, Tokyo (JP)

(21) Appl. No.: 19/295,035

(22) Filed: Aug. 8, 2025

Related U.S. Application Data
(63) Continuation of application No. PCT/JP2024/005298, filed on Feb. 15, 2024.

(30) Foreign Application Priority Data
Feb. 17, 2023 (JP) 2023-022998

(51) Int. Cl. B60W 30/18; B60W 30/182; B60W 60/00

(52) U.S. Cl. CPC B60W 30/18159; B60W 30/182; B60W 60/001; B60W 60/0053; B60W 2510/20; B60W 2552/10; B60W 2552/15; B60W 2552/30; B60W 2554/4045; B60W 2710/207

(57) ABSTRACT

A vehicle control device that autonomously controls driving of a subject vehicle is configured to recognize environment information at an intersection, and set an angle of a steering wheel of the subject vehicle in a case where the subject vehicle temporarily stops. The environment information includes a size of the intersection. The vehicle control device sets the angle of the steering wheel such that, when the size of the intersection is equal to or greater than a preset threshold value, the steering wheel is oriented toward the traveling direction after the right or left turn, relative to the orientation of the vehicle body of the subject vehicle. The vehicle control device sets the angle of the steering wheel such that, when the size of the intersection is smaller than the preset threshold value, the steering wheel is oriented in alignment with the orientation of the vehicle body.

### CROSS-REFERENCE TO RELATED APPLICATIONS

The present application is a continuation application of International Patent Application No. PCT/JP2024/005298 filed on Feb. 15, 2024 which designated the U.S. and claims the benefit of priority from Japanese Patent Application No. 2023-022998 filed on Feb. 17, 2023. The entire disclosures of all of the above applications are incorporated herein by reference.

### TECHNICAL FIELD

The disclosure according to this specification relates to a technique for autonomously controlling driving of a vehicle.

### BACKGROUND

In a related art, in a technique for autonomously controlling driving of a vehicle, environment information around an intersection is recognized. When the subject vehicle turns right or left at an intersection, in a case where the traction control is activated and the subject vehicle waits for a right or left turn, the subject vehicle is determined to be in a safe position, and then the subject vehicle waits for a right or left turn at the safe waiting place.

### SUMMARY

According to an aspect of the present disclosure, a vehicle control device autonomously controls driving of a subject vehicle. The vehicle control device comprising at least one of (i) a circuit and (ii) a processor with a memory storing computer program code executable by the processor, the at least one of the circuit and the processor configured to cause the vehicle control device to recognize environment information at an intersection, and set, using the environment information, an angle of a steering wheel of the subject vehicle in a case where the subject vehicle temporarily stops while making a right or left turn at the intersection. The environment information may include a size of the intersection. The vehicle control device may set the angle of the steering wheel such that, when the size of the intersection is equal to or greater than a preset threshold value, the steering wheel is oriented toward a traveling direction after the right or left turn, relative to an orientation of a vehicle body of the subject vehicle, and the vehicle control device may set the angle of the steering wheel such that, when the size of the intersection is smaller than the preset threshold value, the steering wheel is oriented in alignment with the orientation of the vehicle body.

### BRIEF DESCRIPTION OF DRAWINGS

Objects, features and advantages of the present disclosure will become more apparent from the following detailed description made with reference to the accompanying drawings. In the drawings:

FIG. 1 is a configuration diagram illustrating an overall image of a vehicle system;

FIG. 2 is a configuration diagram illustrating details of an automated driving ECU;

FIG. 3 is a diagram for describing angles α and β;

FIG. 4 is a diagram for describing an angle γ;

FIG. 5 is a diagram for describing a posture PA;

FIG. 6 is a diagram for describing a posture PB;

FIG. 7 is a diagram for describing a posture PC;

FIG. 8 is a diagram for describing a posture PD;

FIG. 9 is a diagram for describing a posture PE;

FIG. 10 is a flowchart illustrating a processing method by the automated driving ECU;

FIG. 11 is a view for describing a crosswalk and consecutive intersections;

FIG. 12 is a flowchart illustrating a processing method by the automated driving ECU;

FIG. 13 is a flowchart illustrating a processing method by the automated driving ECU;

FIG. 14 is a diagram illustrating an example of a plurality of lanes for a right or left turn;

FIG. 15 is a flowchart illustrating a processing method by the automated driving ECU;

FIG. 16 is a view illustrating an example in which an oncoming vehicle is present;

FIG. 17 is a flowchart illustrating a processing method by the automated driving ECU;

FIG. 18 is a diagram illustrating an example in which tracks interfere;

FIG. 19 is a flowchart illustrating a processing method by the automated driving ECU;

FIG. 20 is a flowchart illustrating a processing method by the automated driving ECU;

FIG. 21 is a flowchart illustrating a processing method by the automated driving ECU;

FIG. 22 is a diagram illustrating an example of a case where the angle α is large;

FIG. 23 is a flowchart illustrating a processing method by the automated driving ECU;

FIG. 24 is a flowchart illustrating a processing method by the automated driving ECU;

FIG. 25 is a flowchart illustrating a processing method by the automated driving ECU;

FIG. 26 is a diagram for describing a roundabout;

FIG. 27 is a flowchart illustrating a processing method by the automated driving ECU;

FIG. 28 is a flowchart illustrating a processing method by the automated driving ECU;

FIG. 29 is a diagram for describing a situation in a roundabout;

FIG. 30 is a flowchart illustrating a processing method by the automated driving ECU;

FIG. 31 is a diagram illustrating an example in which an oncoming vehicle is present;

FIG. 32 is a flowchart illustrating a processing method by the automated driving ECU;

FIG. 33 is a flowchart illustrating a processing method by the automated driving ECU;

FIG. 34 is a flowchart illustrating a processing method by the automated driving ECU;

FIG. 35 is a configuration diagram illustrating details of an automated driving ECU; and

FIG. 36 is a flowchart illustrating a processing method by the automated driving ECU.

### DETAILED DESCRIPTION

In the technique of the related art, the temporary stop position for a right or left turn is set according to the environment information of the intersection. However, since it is not considered to smooth the start of the subject vehicle after the temporary stop, there is room for improving convenience.

The present disclosure provides a vehicle control device, a vehicle control program, and a vehicle control method that improve convenience in driving.

According to one aspect of the present disclosure, a vehicle control device autonomously controls driving of a subject vehicle. The vehicle control device includes: an environment recognition section configured to recognize environment information at an intersection; and a setting section configured to set, using the environment information, an angle of a steering wheel of the subject vehicle in a case where the subject vehicle temporarily stops while making a right or left turn at the intersection. The environment information includes a size of the intersection. The setting section sets the angle of the steering wheel such that, when the size of the intersection is equal to or greater than a preset threshold value, the steering wheel is oriented toward a traveling direction after the right or left turn, relative to an orientation of a vehicle body of the subject vehicle, and the setting section sets the angle of the steering wheel such that, when the size of the intersection is smaller than the preset threshold value, the steering wheel is oriented in alignment with the orientation of the vehicle body.

According to such an aspect, in a case where the subject vehicle temporarily stops along with a right or left turn at an intersection, the angle of the steering wheel can be optimized in consideration of the start after the temporary stop according to the environment of the intersection. Therefore, it is possible to smoothly complete the right or left turn after restarting. Therefore, convenience in driving can be improved.

Hereinafter, a plurality of embodiments will be described with reference to the drawings. The same reference numerals are given to corresponding components in each embodiment, and redundant description may be omitted. In a case where only part of the configuration is described in each embodiment, the configuration of the other embodiments described above can be applied to other parts of the configuration. In addition, not only a combination of configurations explicitly described in the description of each embodiment but also configurations of a plurality of embodiments can be partially combined even if not explicitly described as long as there is no problem in the combination.

### First Embodiment

A vehicle system 1 can be used, for example, in a vehicle at the automation level 2 to 5 capable of executing autonomous control of driving (hereinafter, autonomous driving control). The vehicle system 1 is mounted on a subject vehicle Am as a vehicle. The automation level is an index indicating a stage of automated driving of the automated driving vehicle, and there may be a plurality of levels, for example, as defined in SAE. The automation level is divided into levels 0 to 5 as follows, for example.

Level 0 is a level at which the driver performs all driving tasks without system intervention. The driving task may be referred to as a dynamic driving task. The driving tasks are, for example, steering, acceleration/deceleration, and surroundings monitoring. Level 0 corresponds to so-called full manual driving. Level 1 is a level at which the system supports either steering or acceleration/deceleration. Level 1 corresponds to so-called driving assistance. Level 2 is a level at which the system supports both steering and acceleration/deceleration. Level 2 corresponds to partial driving automation. For example, in Levels 1 to 2, the driver has the monitoring obligation (hereinafter, monitoring obligation) related to safe driving. That is, levels 1 to 2 may be classified as manual driving in a broad sense. The monitoring obligation includes visual surroundings monitoring.

Level 3 is a level at which the system is capable of performing all driving tasks under certain conditions and at which a driver performs a driving operation in an emergency. In the automated driving at Level 3, in a case where there is a driving-mode switch request from the system, it is required that the driver can respond quickly. This driving-mode switch (also referred to as a handover of driving control) can be referred to as transfer of the surroundings monitoring obligation from the vehicle system to the driver. Level 3 corresponds to so-called conditional driving automation. Level 3 includes an area-limited level 3 limited to a specific area. The specific area referred to herein may be an expressway. The specific area may be, for example, a specific lane. Level 3 includes a congestion limited level 3 limited to congestion. The automated driving at the congestion limited level 3 corresponds to the congestion limited automated driving. The congestion limited level 3 may be configured to be limited to, for example, congestion on an expressway. The expressway may include an automobile exclusive road.

Level 4 is a level at which the system can perform all driving tasks except under specific situations such as unsupportable roads and extreme environments. Level 4 corresponds to so-called advanced driving automation. The automated driving at Level 5 is a level at which the system can perform all driving tasks under any environment. Level 5 corresponds to so-called full driving automation. The automated driving at Levels 4 and 5 may be performed, for example, in a travel section in which highly accurate map data is prepared. The highly accurate map data will be described later.

For example, Levels 4 to 5 may be classified as automated driving. The automated driving at Levels 3 to 5 can be said to be automated driving in which the driver has no monitoring obligation. During automated driving at Level 3 to 5, a second task may be permitted. The second task is an action other than driving permitted to the driver, and is a specific action defined in advance. The second task can be rephrased as work other than the driving task. The second task can be referred to as a secondary activity, another activity, or the like. The second task should not prevent the driver from responding to the driving operation takeover request (hereinafter, the driving-mode switch request) from the system. As an example, actions such as viewing content such as a moving image, operating a smartphone or the like, reading, and eating are assumed as the second task.

Among the automated driving of Levels 3 to 5, the automated driving of Level 4 or higher corresponds to the automated driving in which the driver is permitted to sleep. That is, it corresponds to sleep permission automated driving. The automated driving at Level 4 or higher can be referred to as automated driving that does not require a driving-mode switch to the driver even in an emergency. Among the automated driving at Levels 3 to 5, the automated driving at level 3 corresponds to automated driving in which driver is not permitted to sleep (hereinafter, sleep non-permission automated driving). It is assumed that the automated driving vehicle of the present embodiment can switch the automation level. The automation level may be configured to be switchable only between some levels of Levels 0 to 5. The automated driving vehicle of the present embodiment can switch at least between automated driving without monitoring obligation and manual driving.

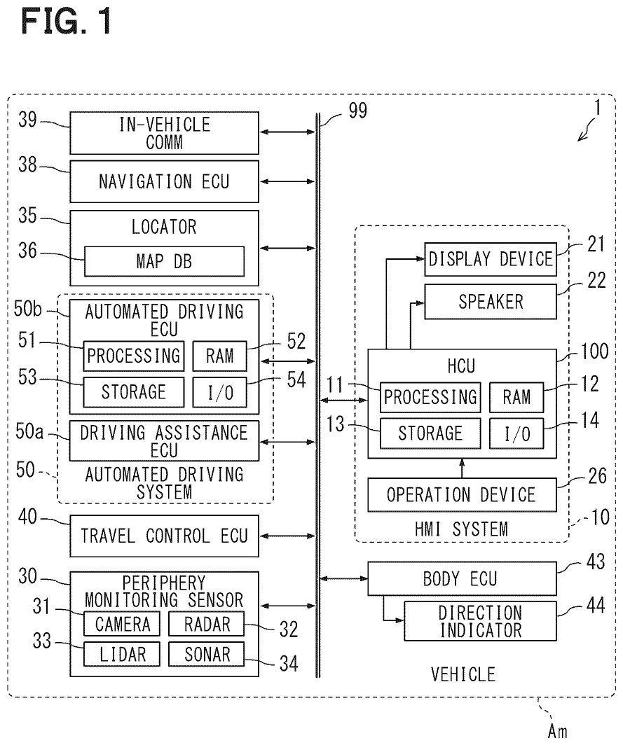

As illustrated in FIG. 1, the vehicle system 1 includes a surroundings monitoring sensor 30, a locator 35, a navigation ECU 38, an in-vehicle communication device 39, a travel control ECU 40, a body ECU 43, a driving assistance ECU 50a, an automated driving ECU 50b, and an HCU 100. The surroundings monitoring sensor 30, the locator 35, the navigation ECU 38, the in-vehicle communication device 39, the travel control ECU 40, the body ECU 43, the driving assistance ECU 50a, the automated driving ECU 50b, and the HCU 100 are communicably connected to a communication bus 99 of an in-vehicle network mounted on the subject vehicle Am. These nodes connected to the communication bus 99 can communicate with each other. Specific nodes among the devices, the ECUs, and the like may be electrically connected to each other directly by a wire harness or the like, and may communicate with each other without via the communication bus 99. The surroundings monitoring sensor 30 may be referred to as a periphery monitoring sensor.

The surroundings monitoring sensor 30 is an autonomous sensor that monitors the surroundings environment of the subject vehicle Am. The surroundings monitoring sensor 30 includes, for example, one or more of a camera unit 31, a millimeter wave radar 32, a lidar 33, and a sonar 34. The surroundings monitoring sensor 30 can detect a moving object and a stationary object from a detection range around the subject vehicle. The surroundings monitoring sensor 30 provides detection information of an object around the subject vehicle to the driving assistance ECU 50a, the automated driving ECU 50b, and the like. In the vehicle system 1 of the present embodiment, a plurality of surroundings monitoring sensors 30 is mounted so that an object can be detected farther ahead and with high accuracy, among ahead of, side of, and behind the subject vehicle Am.

The locator 35 includes a global navigation satellite system (GNSS) receiver, an inertial sensor, and the like. The locator 35 combines positioning signals received from a plurality of positioning satellites by the GNSS receiver, measurement results by the inertial sensor, vehicle speed information output to the communication bus 99, and the like to sequentially measure the position, the traveling direction, and the like of the subject vehicle Am. The locator 35 sequentially outputs the position information and the orientation information of the subject vehicle Am based on the positioning result to the communication bus 99 as locator information.

The navigation ECU 38 acquires information about a destination designated by the occupant including the driver based on the operation information acquired from the HCU 100. The navigation ECU 38 acquires subject vehicle position information and orientation information from the locator 35, and sets a route from the current position to the destination. The navigation ECU 38 provides route information indicating a setting route to a destination to the driving assistance ECU 50a, the automated driving ECU 50b, the HCU 100, and the like. The navigation ECU 38 cooperates with the HMI system 10 to combine the screen display, the voice message, and the like as the route guidance to the destination, and notifies the driver of the traveling direction TD1 of the subject vehicle Am at the intersection IS, the branch point, and the like.

Here, a user terminal such as a smartphone may be connected to the in-vehicle network or the HCU 100. Such a user terminal may provide subject vehicle position information, orientation information, map data, and the like to the driving assistance ECU 50a, the automated driving ECU 50b, and the like instead of the locator 35. Further, instead of the navigation ECU 38, the user terminal may provide route information to the destination to the driving assistance ECU 50a, the automated driving ECU 50b, the HCU 100, and the like.

The in-vehicle communication device 39 is an out-of-vehicle communication unit mounted on the subject vehicle Am, and functions as a vehicle to everything (V2X) communication device. The in-vehicle communication device 39 transmits and receives information to and from a roadside device installed beside a road by wireless communication. As an example, the in-vehicle communication device 39 receives congestion information, road construction information, and the like around the current position of the subject vehicle Am and in the traveling direction TD1 from the roadside device. The congestion information and the road construction information are VICS (registered trademark) information and the like. The in-vehicle communication device 39 provides the received congestion information and road construction information to the automated driving ECU 50b, the HCU 100, and the like.

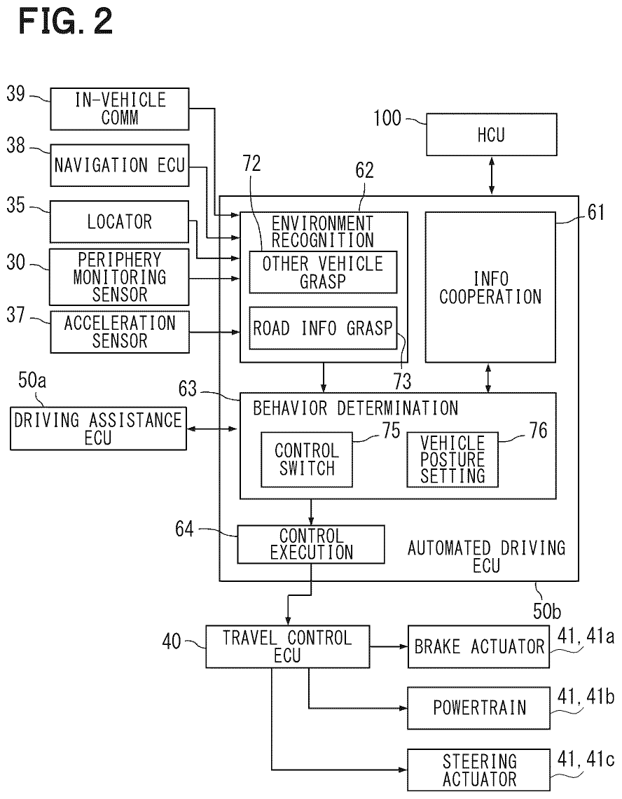

The travel control ECU 40 is an electronic control device mainly including a microcontroller. The travel control ECU 40 has at least functions of a brake control ECU, a drive control ECU, and a steering control ECU. The travel control ECU 40 operates a driving actuator 41 based on any one of an operation command based on the driving operation by the driver, a control command of the driving assistance ECU 50a, and a control command of the automated driving ECU 50b. As illustrated in FIG. 2, the driving actuator 41 includes a brake actuator 41a for controlling braking force of each wheel, a power train 41b for controlling acceleration of the vehicle, and a steering actuator 41c for controlling steering.

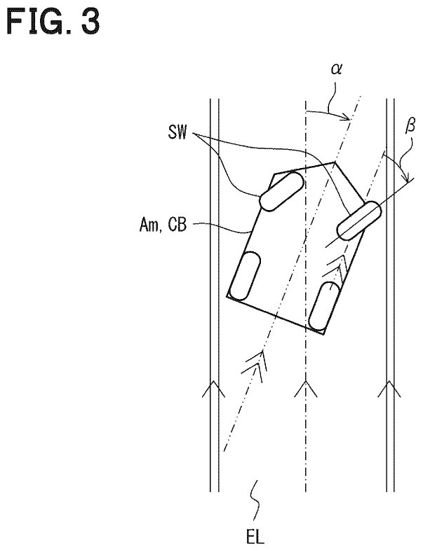

The steering actuator 41c is configured to change the angle β of the steering wheel SW in the subject vehicle Am. For example, in the present embodiment, the traveling directions TD0 and TD1 of the subject vehicle Am can be controlled by controlling the angles of the two front wheels that are the steering wheels SW among the four wheels of the subject vehicle Am. For example, as illustrated in FIG. 3, the angle β in the present embodiment may mean a direction of the steering wheel SW with respect to a reference angle in a case where a state in which the steering wheel SW is along ahead (straight traveling direction) of a vehicle body CB is set as the reference angle. The steering wheels may be referred to as steered wheels.

In cooperation with the steering actuator 41c operating the steering wheel SW, the annular steering operation section operable by the driver in the subject vehicle Am is configured to rotate. The ratio between the rotation amount of the steering operation section and the angle change amount of the steering wheel SW is set to be substantially the same as the ratio in a case where the driver manually operates the steering operation section. With such a configuration, even during the autonomous driving control, the occupant can visually understand how the subject vehicle Am is steered.

The body ECU 43 is an electronic control device mainly including a microcontroller. The body ECU 43 has a function of controlling operation of a lighting device mounted on the subject vehicle Am. The lighting device is, for example, a direction indicator 44 or a hazard lamp. The body ECU 43 starts blinking of one of left and right direction indicators 44 corresponding to an operation direction based on detection of a user operation input to a direction indication switch (indicator lever) provided in a steering column section or the like. During the autonomous driving control, the body ECU 43 can blink the direction indicators 44 along with a right or left turn at the intersection IS based on a control command from the automated driving ECU 50b.

As illustrated in FIG. 1, the HCU 100 is electrically connected to notification devices such as a display device 21 and a speaker 22, and an operation device 26. The HCU 100, the display device 21, the speaker 22, and the operation device 26 constitute the HMI system 10 of the subject vehicle Am. A plurality of display devices 21, a plurality of speakers 22, and a plurality of operation devices 26 may be provided.

The display device 21 makes a notification of information through vision of the driver or another occupant by image display or the like. The display device 21 may include a meter display, a center information display (CID), a head-up display (hereinafter, HUD), and the like. The CID has a touch panel function, and detects a touch operation on a display screen by a driver or another occupant. That is, the CID corresponds to the operation device 26. The HUD can display a virtual image floating outside the vehicle. The speaker 22 is installed in the vehicle interior and reproduces a notification sound, a voice message, or the like in the vehicle interior.

The operation device 26 is an input section that receives a user operation by a driver or another occupant. For example, a user operation related to the operation and stop of the automated driving function, a user operation related to the setting of the destination of the route guidance, and the like are input to the operation device 26. The operation device 26 includes the direction indication switch, the switch of the hazard lamp, and the CID described above. In addition, the operation device 26 includes a steering switch provided on a spoke portion of the steering operation section, a voice input device that recognizes utterance content of a driver or another occupant, and the like.

The HCU 100 is an information presentation device that integrally controls a notification using the plurality of display devices 21 and the speaker 22. The HCU 100 controls a notification of information about automated driving in cooperation with an automated driving system 50. The HCU 100 is a computer mainly including a control circuit including a processing section 11, a RAM 12, a storage section 13, an input/output interface 14, a bus connecting these, and the like. The processing section 11 executes various processes for the notification control process by accessing the RAM 12. The RAM 12 may include a video RAM for generating video data. The storage section 13 stores various programs to be executed by the processing section 11.

The processing section 11 may include at least one processor. The processor includes, as a core, at least one of, for example, a central processing unit (CPU), a graphics processing unit (GPU), a reduced instruction set computer (RISC)-CPU, and the like. The storage section 13 may include at least one type of non-transitory tangible storage medium among, for example, a semiconductor memory, a magnetic medium, an optical medium, and the like that non-transiently stores programs, data, and the like readable by the processor.

The driving assistance ECU 50a and the automated driving ECU 50b constitute the automated driving system 50 of the subject vehicle Am. The driving assistance ECU 50a implements a driving assistance function of assisting the driving operation by the driver in the automated driving system 50. The driving assistance ECU 50a enables driving assistance of about Level 2 or partial automated driving.

The automated driving ECU 50b is capable of substituting for the driving operation by the driver, and is capable of performing automated driving of Level 3 or higher in which the system is a control subject. The automated driving performed by the automated driving ECU 50b is the automated driving of eyes-off in which the driver is not obliged to monitor the surroundings, that is, the driver is not obliged to monitor the surroundings.

In the automated driving system 50 described above, the travel control state of the automated driving function is switched among a plurality of states including at least driving assistance control in which the driving assistance ECU 50a is obliged to monitor the surroundings and automated driving control in which the automated driving ECU 50b is not obliged to monitor the surroundings.

The driving assistance ECU 50a is a computer mainly including a control circuit including a processing section, a random access memory (RAM), a storage section, an input/output interface, a bus connecting these, and the like. The driving assistance ECU 50a implements driving assistance functions such as adaptive cruise control (ACC), lane trace control (LTC), and lane change assist (LCA) by executing a program in the processing section. The ACC, the LTC, and the LCA are referred to as applications for driving assistance. The driving assistance ECU 50a provides control status information indicating a state of driving assistance control to the automated driving ECU 50b.

The processing section may include at least one processor. The processor includes, as a core, at least one of, for example, a central processing unit (CPU), a graphics processing unit (GPU), a reduced instruction set computer (RISC)-CPU, and the like. The storage section may include at least one type of non-transitory tangible storage medium among, for example, a semiconductor memory, a magnetic medium, an optical medium, and the like that non-transiently stores programs, data, and the like readable by the processor.

The automated driving ECU 50b has higher calculation capability than the driving assistance ECU 50a, and can perform at least travel control corresponding to ACC and LTC. The automated driving ECU 50b may be capable of performing driving assistance control in which the driver is obliged to monitor the surroundings instead of the driving assistance ECU 50a in a scene where the control by the driving assistance ECU 50a is temporarily interrupted.

The automated driving ECU 50b is a computer mainly including a control circuit including a processing section 51, a RAM 52, a storage section 53, an input/output interface 54, a bus connecting these, and the like. The processing section 51 executes various processes for realizing the automated driving control method of the present disclosure by accessing the RAM 52. The storage section 53 stores various programs to be executed by the processing section 51. The program includes a vehicle control program for autonomous control of driving of the vehicle.

The processing section 51 may include at least one processor. The processor includes, as a core, at least one of, for example, a central processing unit (CPU), a graphics processing unit (GPU), a reduced instruction set computer (RISC)-CPU, and the like. The storage section 53 may include at least one type of non-transitory tangible storage medium among, for example, a semiconductor memory, a magnetic medium, an optical medium, and the like that non-transiently stores programs, data, and the like readable by the processor.

By execution of the program by the processing section 51, in the automated driving ECU 50b, an information linkage section 61, an environment recognition section 62, an action determination section 63, a control execution section 64, and the like are constructed as a plurality of function sections for realizing the automated driving function (see FIG. 2). The information linkage section 61 may be referred to as an information cooperation section. The action determination section 63 may be referred to as a behavior determination section.

The information linkage section 61 provides information to the HCU 100 and acquires information from the HCU 100. Through the cooperation, the automated driving ECU 50b and the HCU 100 share the information acquired by each. The information linkage section 61 generates control status information indicating an operation state of the automated driving function, and provides the generated control status information to the HCU 100.

The information linkage section 61 enables a notification by the HCU 100 synchronized with the operation state of the automated driving function by outputting control status information to an information linkage section 82. In addition, the information linkage section 61 acquires operation information or the like of the driver or another occupant from the information linkage section 82, and grasps the content of the user operation input to the HMI system 10 or the like.

The environment recognition section 62 recognizes environment information around the subject vehicle Am. The environment information may be recognized as being acquired from the in-vehicle communication device 39, the locator 35, the surroundings monitoring sensor 30, and the like. The environment information may be recognized by fusing information acquired by the in-vehicle communication device 39, the locator 35, the surroundings monitoring sensor 30, and the like.

The environment recognition section 62 includes an another vehicle grasping section 72 and a road information grasping section 73 as sub-function sections for travel environment recognition. The another vehicle grasping section 72 grasps a relative position, a relative speed, and the like of a dynamic target around the subject vehicle, such as another vehicle traveling around the subject vehicle Am. The another vehicle grasping section 72 grasps at least a preceding vehicle and a following vehicle traveling in the same lane (hereinafter, a subject lane) as the subject vehicle Am, and a side vehicle traveling in an adjacent lane adjacent to the subject lane. In a case where the subject vehicle Am travels on a road with three or more lanes, the another vehicle grasping section 72 grasps a side vehicle traveling in a lane located opposite the subject lane with the adjacent lane interposed therebetween.

In addition, the another vehicle grasping section 72 grasps another vehicle present in the intersection IS which the subject vehicle Am is about to enter or already has entered, and another vehicle present outside the intersection IS and around the intersection IS. The information about the another vehicle is included in the environment information about the intersection IS.

The road information grasping section 73 grasps information about a road on which the subject vehicle Am travels. In a case where the route information is acquired from the navigation ECU 38, the road information grasping section 73 extracts a specific point of the road on which the subject vehicle Am is scheduled to travel, specifically, the intersection IS, a branch point (junction or the like) of an expressway, a merging point, an exit point, and the like. Further, the road information grasping section 73 grasps, for the road on which the subject vehicle Am is scheduled to travel, a congestion section in which congestion has occurred, a restriction section in which restriction has occurred due to road construction or the like, and the like.

The road information grasping section 73 grasps at least part of the environment information of the intersection IS as more detailed road information. The environment information about the intersection IS includes at least one piece of information about the shape of the intersection IS, information about the road connected to the intersection IS, information about the traffic signal CTS of the intersection IS, information about the road surface mark of the intersection IS, and the like.

The information about the shape of the intersection IS may include at least one of the size of the intersection IS, the number of roads connected to the intersection IS, the orientation of the road connected to the intersection IS, and the like.

The information about the road to which the intersection IS is connected may include at least one of the number of lanes of the connection road, the role (left turn dedicated lane, right turn dedicated lane, etc.) of each lane in the connection road, and the like.

The information about the traffic signal CTS at the intersection IS may include at least one of the presence or absence of the traffic signal CTS, the position and the display direction of the traffic signal CTS, the presence or absence of the arrow signal ATS at the traffic signal CTS, the control information about the traffic signal CTS, and the like.

The information about the road surface mark of the intersection IS may include at least one of the presence or absence and the position of the crosswalk, the presence or absence and the position of the stop line SL, the presence or absence and the position of the waveguide, the presence or absence and the position of the safety zone, the presence or absence and the position of the restriction arrow, and the like.

The action determination section 63 cooperates with the driving assistance ECU 50a and the HCU 100 to control the driving-mode switch between the automated driving system 50 and the driver. In a case where the automated driving ECU 50b has the control right of the driving operation, the action determination section 63 generates a traveling track on which the subject vehicle Am is scheduled to travel based on the recognition result of the travel environment by the environment recognition section 62 to output the generated traveling track to the control execution section 64. The action determination section 63 includes a control switching section 75 and a vehicle posture setting section 76 as sub-function sections for controlling the operation state of the automated driving function.

The control switching section 75 cooperates with the driving assistance ECU 50a to switch between the driving control at Level 2 in which the driver is obliged to monitor the surroundings and driving control in which the driver is not obliged to monitor the surroundings. In addition, the control switching section 75 switches between the automated driving at Level 3 and the automated driving at Level 4. Furthermore, the control switching section 75 switches the control state of automated driving at Level 3 among a plurality of control states including area-limited control (area level 3) performed only for traveling within a specific area and congestion limited control (hereinafter, congestion level 3) performed only for traveling in congestion. The automated driving of Level 3 or higher corresponds to the autonomous driving control in the present embodiment.

The vehicle posture setting section 76 sets the vehicle posture in a case where the subject vehicle Am temporarily stops at the time of performing the autonomous driving control. The vehicle posture includes the orientation of the vehicle body CB and the angle β of the steering wheel SW. The vehicle posture setting section 76 may directly set numerical values representing the orientation of the vehicle body CB and the angle β of the steering wheel SW. Alternatively, vehicle posture setting section 76 may set the vehicle posture by selecting a posture to be used from a plurality of predefined vehicle postures.

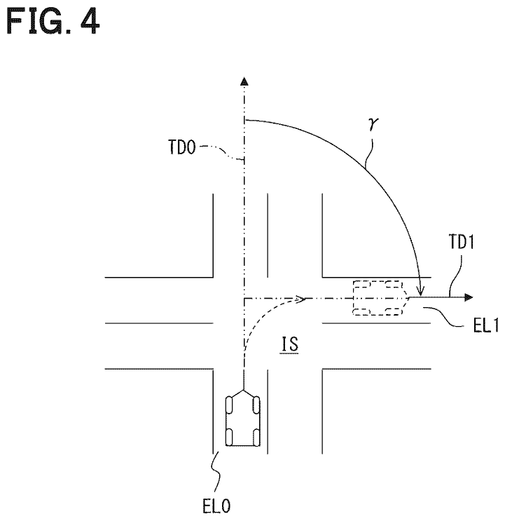

Here, a scene in which the subject vehicle Am makes a right or left turn at the intersection IS on the premise of left-hand traffic based on the road traffic law in Japan will be considered. The right or left turn here is a concept including a right turn and a left turn. In practice, since right turn and left turn cannot be simultaneously executed, a right or left turn means either a right turn or a left turn. Hereinafter, it is assumed that the subject vehicle Am turns right at the intersection IS. As illustrated in FIG. 4, the right or left turn angle γ (here, the angle at which the subject vehicle Am turns when turning right) is based on the orientation of the road connected to the intersection IS. It can be said that the right or left turn angle γ is an angle formed by a traveling direction TD1 in a subject lane EL1 in which the vehicle travels after the right turn with respect to a traveling direction TD0 in a subject lane EL0 before the right turn (in other words, before entering the intersection IS).

For example, in a case where the traffic signal CTS displays a stop signal (for example, a red light) or in a case where priority is given to passage of another vehicle such as an oncoming vehicle going straight and a pedestrian, the subject vehicle Am is required to temporarily stop before turning right. This temporary stop may be a temporary stop in the intersection IS, or may be a temporary stop before entering the intersection IS. Here, the following five types of postures PA, PB, PC, PD, and PE are assumed as the vehicle posture at the temporary stop in the intersection IS.

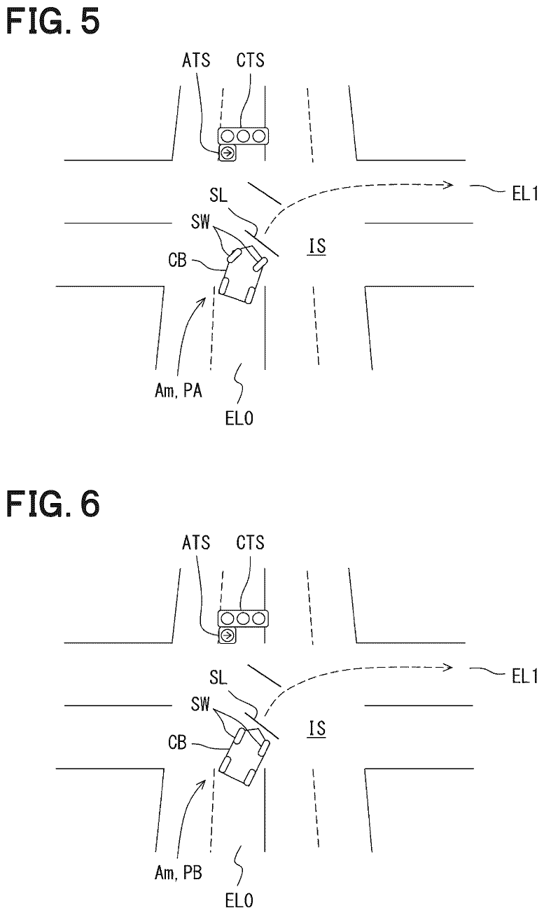

The posture PA is illustrated in FIG. 5. In the posture PA, the orientation of the vehicle body CB in the temporary stop is a direction inclined so as to face in the traveling direction after turning right with respect to the subject lane EL0 before entering the intersection IS. Here, the inclination angle α (see FIG. 3) of the vehicle body CB with respect to the subject lane EL0 is set to be smaller than the right or left turn angle γ. The steering wheel SW is inclined to face in the traveling direction TD0 after turning right with respect to the vehicle body CB. Here, the sum of the inclination angle α and the angle β of the steering wheel SW is set to be smaller than the right or left turn angle γ. The posture PA is suitable for a case where at a relatively large intersection IS, for example, the stop line SL as a road mark in the intersection IS is provided to be inclined with respect to the subject lane EL0 before entering the intersection IS.

The posture PB is illustrated in FIG. 6. In the posture PB, the orientation of the vehicle body CB in the temporary stop is a direction inclined so as to face in the traveling direction after turning right with respect to the subject lane EL0 before entering the intersection IS. Here, the inclination angle α of the vehicle body CB with respect to the subject lane EL is set to be smaller than the right or left turn angle γ. The steering wheel SW is substantially in the same orientation as the vehicle body CB. That is, the angle β is substantially 0 degrees. The posture PB is suitable for a case where at a relatively large intersection IS, for example, the stop line SL as a road mark in the intersection IS is provided to be inclined with respect to the subject lane EL0 before entering the intersection IS.

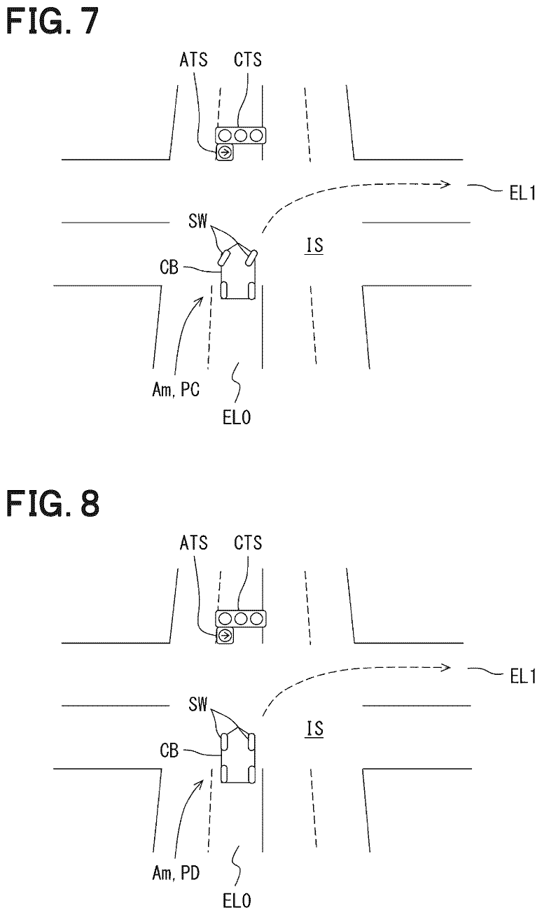

The posture PC is illustrated in FIG. 7. In the posture PC, the orientation of the vehicle body CB in the temporary stop is the orientation along the subject lane EL0 before the vehicle enters the intersection IS. The steering wheel SW is inclined to face in the traveling direction TD1 after turning right with respect to the vehicle body CB. Here, the angle β of the steering wheel SW is set to be smaller than the right or left turn angle γ. The posture PC is suitable for a case where at a relatively small intersection IS, for example, the stop line SL as a road mark in the intersection IS is not provided.

The posture PD is illustrated in FIG. 8. In the posture PD, the orientation of the vehicle body CB in the temporary stop is the orientation along the subject lane EL0 before the vehicle enters the intersection IS. The steering wheel SW is substantially in the same orientation as the vehicle body CB. That is, the angle β of the steering wheel SW is substantially 0 degrees. The posture PC is suitable for a case where at a relatively small intersection IS, for example, the stop line SL as a road mark in the intersection IS is not provided.

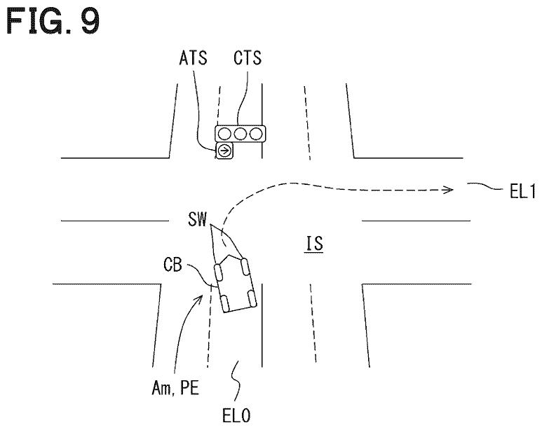

The posture PE is illustrated in FIG. 9. In the posture PE, the orientation of the vehicle body CB in the temporary stop is an orientation inclined so as to face in a direction opposite the traveling direction after turning right with respect to the subject lane EL0 before entering the intersection IS. The steering wheel SW is substantially in the same orientation as the vehicle body CB. That is, the angle β of the steering wheel SW is substantially 0 degrees.

The vehicle posture setting section 76 of the present embodiment decides the vehicle posture at the time of temporary stop based on the size of the intersection IS. Specifically, the vehicle posture setting section 76 alternatively selects the most appropriate vehicle posture from the above-described postures PA, PB, and PD.

Here, the angle β of the steering wheel SW is set to be inclined so as to face in the traveling direction after turning right with respect to the vehicle body CB in the posture PA, while the steering wheel SW faces in the orientation substantially same as orientation of the vehicle body CB in the postures PB and PD. In a case where the intersection IS is larger than a preset threshold value, the posture PA is selected. In other words, in a case where the size of the intersection IS is larger than the predetermined threshold value, the angle β is set to be inclined so as to face in the traveling direction after turning right with respect to the vehicle body CB. Conversely, at the small intersection IS, if the angle β is formed, there is a possibility that the overhang of the steering wheel SW is an obstacle and the traffic flow is obstructed, and thus the angle β is 0.

The size of the intersection IS herein may be simply defined by the area of the entire intersection IS. The size of the intersection IS may be defined by a distance between an end of a road on which the subject vehicle Am is traveling before turning right or left (in other words, a connection portion with the intersection IS) and an end of a road opposite to the road.

In a case where the automated driving ECU 50b has the control right of the driving operation, the control execution section 64 executes acceleration/deceleration control, steering control, and the like of the subject vehicle Am in accordance with the traveling track generated by the action determination section 63 in cooperation with the travel control ECU 40. Specifically, the control execution section 64 generates a control command for each driving actuator based on the scheduled traveling track, and sequentially outputs the generated control command to the travel control ECU 40.

In a case where the vehicle posture setting section 76 sets the vehicle posture in the temporary stop described above, such a control execution section 64 generates a control command so that the operation from the traveling state to the temporary stop is completed in the posture. That is, the angle β of the steering wheel SW in the vehicle posture can be changed during the temporary stop. However, if the angle β is changed during the temporary stop, the steering wheel SW is rubbed against the road surface, so that the steering wheel SW and the road surface are worn. In addition, there is a possibility that the subject vehicle Am cannot smoothly restart in a case where it is necessary to restart during the angle changing operation.

From this, the control execution section 64 calculates the output to each driving actuator 41 so that the angle β of the steering wheel SW gradually approaches the set posture from the traveling state to the temporary stop, and the angle β is the set angle when the operation to the temporary stop is completed. Each driving actuator 41 is operated by the control command based on such calculation, so that a series of traveling operations before and after the temporary stop of the intersection IS is smoothed.

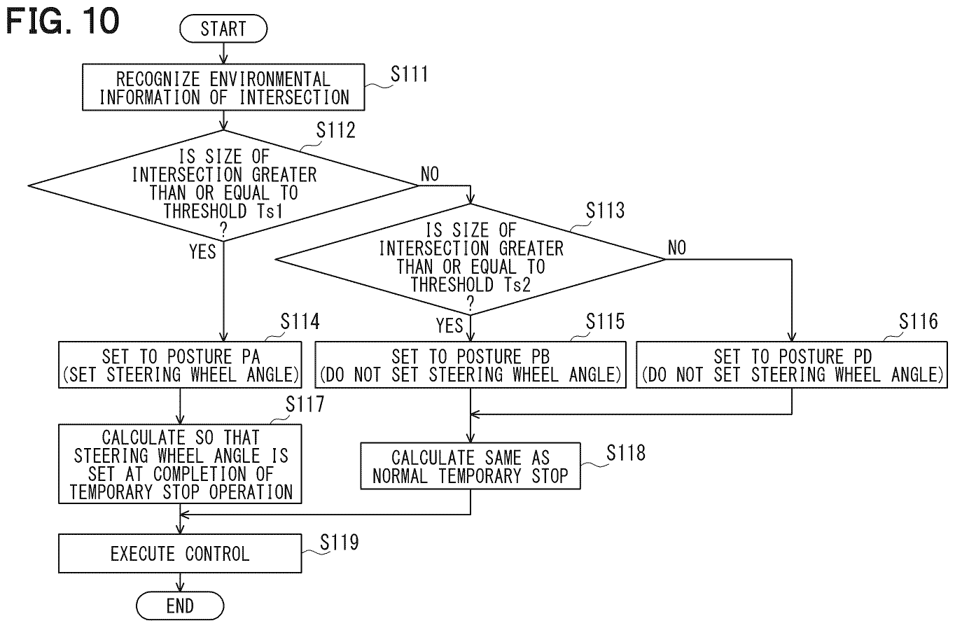

Next, an example of a processing method by the automated driving ECU 50b will be described with reference to a flowchart of FIG. 10. The series of processes shown in steps S111 to 118 is executed based on a predetermined trigger by at least one processor of the automated driving ECU 50b executing a program. This series of processes is executed in a case where the driving of the subject vehicle Am is autonomously controlled and the subject vehicle Am is scheduled to turn right or left at the intersection IS.

In S111, the environment recognition section 62 recognizes the environment information of the intersection IS. After the process of S111, the process proceeds to S112.

In S112, the environment recognition section 62 determines whether the size of the intersection IS is equal to or larger than a preset threshold value Ts1. In a case of Yes, the process proceeds to S114. In a case of No, the process proceeds to S113.

In S113, the vehicle posture setting section 76 determines whether the size of the intersection IS is equal to or larger than a preset threshold value Ts2. Here, it is assumed that the threshold value Ts2 is a value smaller than Ts1. In a case of Yes, the process proceeds to S115. In a case of No, the process proceeds to S116.

In S114, the vehicle posture setting section 76 sets the vehicle posture at the temporary stop at the intersection IS to the posture PA (see FIG. 5). That is, the angle β of the steering wheel SW is formed with respect to the vehicle body CB. After the process of S114, the process proceeds to S117.

In S115, the vehicle posture setting section 76 sets the vehicle posture at the temporary stop at the intersection IS to the posture PB (see FIG. 6). That is, the angle β is not set. After the process of S115, the process proceeds to S118.

In S116, the vehicle posture setting section 76 sets the vehicle posture at the temporary stop at the intersection IS to the posture PD (see FIG. 8). That is, the angle β is not set. After the process of S115, the process proceeds to S118.

In S117 when the angle β is formed, the control execution section 64 calculates a value of the output to the driving actuator 41 so that the angle β is formed when the temporary stop operation is completed. After the process of S117, the process proceeds to S119.

In S118 when the angle β is not set, the control execution section 64 calculates the value of the output to the driving actuator 41 as in the normal temporary stop. That is, the value of the output to the driving actuator 41 is calculated so that the angle β is substantially 0 when the temporary stop operation is completed. After the process of S118, the process proceeds to S119.

In S119, the control execution section 64 executes control by outputting a control command based on the calculation of S117, 118 to the travel control ECU 40. The series of processes terminates at S119.

The size of the intersection IS may be the area of the intersection IS, and the threshold values Ts1 and Ts2 may be values corresponding to the area. In addition, the size of the intersection IS may be represented as data classified into “large”, “medium”, and “small” in the map DB 36 or the like. In this case, a determination condition corresponding to the determination with the threshold value Ts1 may be set so that “large” is determined as Yes and “medium” and “small” are determined as No in S112. In S113, a determination condition corresponding to the determination with the threshold value Ts2 may be set so that “medium” is determined as Yes and “small” is determined as No.

According to the first embodiment described above, in a case where the subject vehicle Am temporarily stops along with a right or left turn at the intersection IS, the angle β of the steering wheel SW can be optimized in consideration of the start after the temporary stop according to the environment of the intersection IS. Therefore, it is possible to smoothly complete the right or left turn after restarting. Therefore, convenience in driving can be improved.

Further, the control of the subject vehicle Am from the traveling to the temporary stop is executed so that the temporary stop operation is completed at the set angle β of the steering wheel SW. By doing so, it is possible to improve smoothness at the time of restarting while avoiding operating the steering wheel SW while being rubbed against the road surface during the temporary stop.

In a case where the size of the intersection IS is equal to or larger than a preset threshold value, the angle β of the steering wheel SW is set so that the steering wheel SW face in the traveling direction TD1 after turning right or left with respect to the orientation of the vehicle body CB of the subject vehicle Am. In a case where it is recognized that forming the angle β does not obstruct the traffic flow, the angle β is formed, so that the smooth traffic flow at the intersection IS can be promoted.

In a case where the size of the intersection IS is smaller than a preset threshold value, the angle β of the steering wheel SW is set so that the orientation of the steering wheel SW is along the orientation of the vehicle body CB of the subject vehicle Am. In a case where it is recognized that forming the angle β inhibits the traffic flow, the angle β is avoided, so that the smooth traffic flow at the intersection IS can be promoted.

In addition, the orientation of the vehicle body CB of the subject vehicle Am with respect to the lane EL0 on which the subject vehicle Am travels before turning right or left is set together with the angle β of the steering wheel SW. By comprehensively setting the vehicle posture, smoothness at the time of restarting can be improved.

The automated driving ECU 40b in the first embodiment corresponds to a “vehicle control device”. The vehicle posture setting section 76 corresponds to a “setting section”.

### Second Embodiment

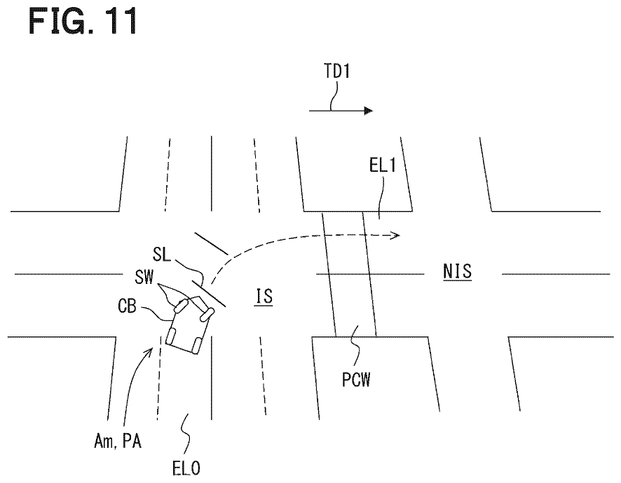

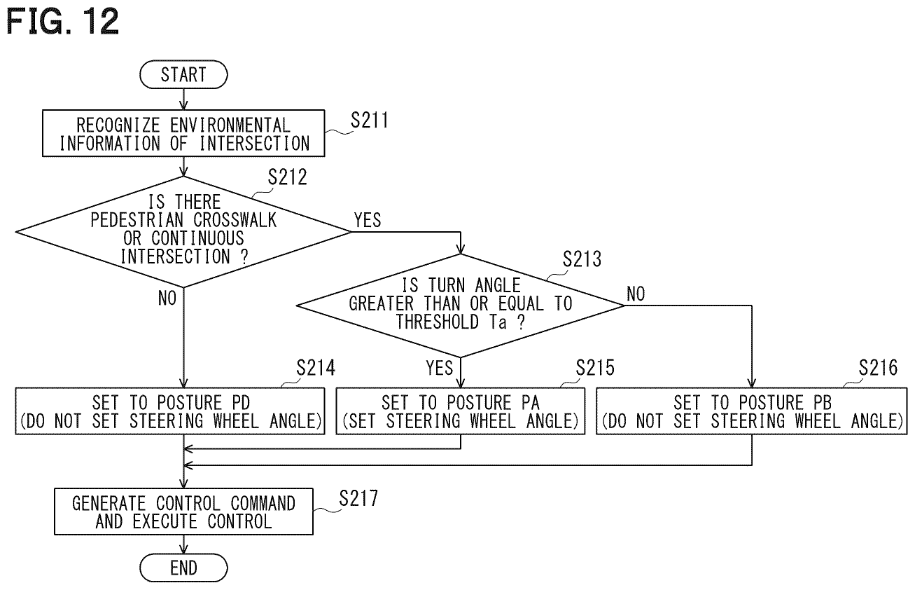

As illustrated in FIGS. 11 and 12, the second embodiment is a modification of the first embodiment. The second embodiment will be described focusing on differences from the first embodiment.

In the second embodiment, the vehicle posture setting section 76 sets the vehicle posture at the temporary stop according to the information indicating the presence or absence of a crosswalk PCW at the intersection IS and the intersection continuation information as the environment information of the intersection IS (see FIG. 11). The crosswalk PCW referred to herein is a crosswalk located in the traveling direction TD1 after turning right or left with respect to the center of the intersection IS.

Further, the intersection continuation information is information that the next intersection NIS is present so as to be continuous in the traveling direction TD1 after the right or left turn of the intersection IS at which the right or left turn is scheduled. The term “continuous” referred to herein may mean that a plurality of intersections IS is present within a distance where an object in front of the subject vehicle Am can be detected by the surroundings monitoring sensor 30.

Here, an example of a processing method by the automated driving ECU 50b in the second embodiment will be described with reference to a flowchart of FIG. 12. The series of processes shown in steps S211 to 217 is executed based on a predetermined trigger by at least one processor of the automated driving ECU 50b executing a program. This series of processes is executed in a case where the driving of the subject vehicle Am is autonomously controlled and the subject vehicle Am is scheduled to turn right or left at the intersection IS.

In S211, the environment recognition section 62 recognizes the environment information of the intersection IS. That is, S211 is similar to S111 of the first embodiment. After the process of S211, the process proceeds to S212.

In S212, the vehicle posture setting section 76 determines whether there is a crosswalk PCW or intersection continuation information at the intersection IS. In a case of Yes, the process proceeds to S213. In a case of No, the process proceeds to S214.

In S213, the vehicle posture setting section 76 determines whether the right or left turn angle γ is equal to or larger than a preset threshold value Ta. For example, the threshold value Ta may be set to a value larger than 90°. Specifically, the threshold value Ta is set to 100°, 110°, 120°, or the like. That is, in a case where the turning amount of the subject vehicle Am at the time of the right or left turn is large, the angle β of the steering wheel SW at the temporary stop is formed so that the subject vehicle Am can turn right or left as tightly as possible after restarting. In a case of Yes, the process proceeds to S215. In a case of No, the process proceeds to S216.

In S214, the vehicle posture setting section 76 sets the vehicle posture at the temporary stop at the intersection IS to the posture PD (see FIG. 8). That is, the angle β is not set. After the process of S214, the process proceeds to S217.

In S215, the vehicle posture setting section 76 sets the vehicle posture at the temporary stop at the intersection IS to the posture PA (see FIG. 5). That is, the angle β is formed. After the process of S215, the process proceeds to S217.

In S216, the vehicle posture setting section 76 sets the vehicle posture at the temporary stop at the intersection IS to the posture PB (see FIG. 6). That is, the angle β is not set. After the process of S216, the process proceeds to S217.

S217 is similar to S117 to 119 of the first embodiment. The series of processes terminates at S217.

According to the second embodiment described above, in a case where there is the crosswalk PCW, the orientation of the vehicle body CB at the temporary stop is set so that the vehicle body CB of the subject vehicle Am faces in a traveling direction after the right or left turn with respect to the lane EL0 on which the subject vehicle Am travels before the right or left turn. The orientation of the vehicle body CB makes it easier for the surroundings monitoring sensor 30 to detect a pedestrian or the like on the crosswalk PCW, so that convenience in driving can be improved.

In a case where the crosswalk PCW is present, the angle β of the steering wheel SW is set so that the steering wheel SW further face in the traveling direction TD1 after turning right or left with respect to the orientation of the vehicle body CB. In this way, since the subject vehicle Am can turn from immediately after restarting, the surroundings monitoring sensor 30 can easily detect a pedestrian or the like on the crosswalk PCW from an early stage after restarting.

In addition, in a case where there is the intersection continuation information, the orientation of the vehicle body CB at the temporary stop is set so that the vehicle body CB of the subject vehicle Am faces in the traveling direction TD1 after the right or left turn with respect to the lane EL0 on which the subject vehicle Am travels before the right or left turn. The orientation of the vehicle body CB makes it easier for the surroundings monitoring sensor 30 to detect the situation of the next intersection NIS, so that convenience in driving can be improved.

In addition, in a case where there is the intersection continuation information, the angle β of the steering wheel SW is set so that the steering wheel SW further face in the traveling direction TD1 after turning right or left with respect to the orientation of the vehicle body CB. In this way, since the subject vehicle Am can turn immediately after restarting, the surroundings monitoring sensor 30 can easily detect the situation of the next intersection NIS from an early stage after restarting.

### Third Embodiment

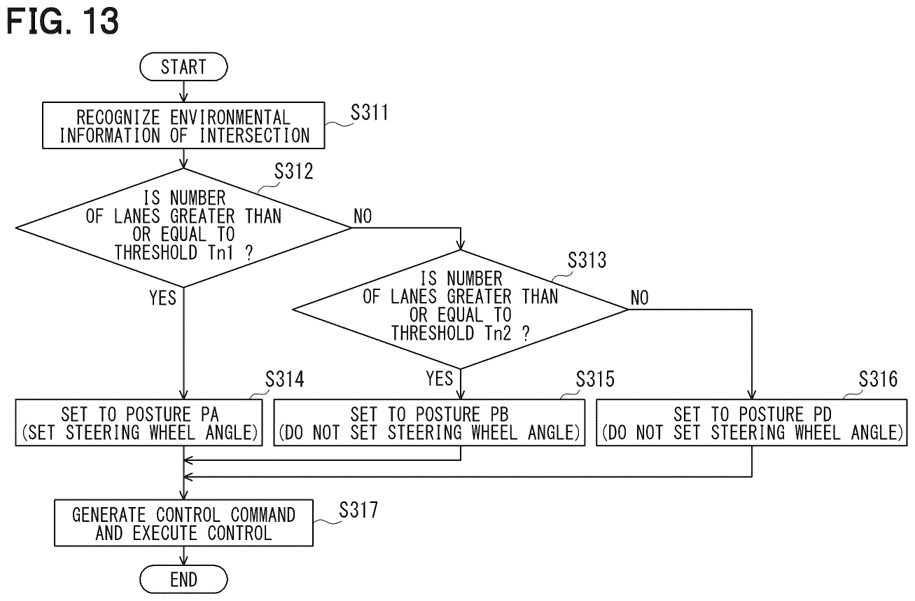

As illustrated in FIG. 13, the third embodiment is a modification of the first embodiment. The third embodiment will be described focusing on differences from the first embodiment.

In the third embodiment, the vehicle posture setting section 76 sets the vehicle posture at the temporary stop according to the number of lanes of the road on which the subject vehicle Am will travel after turning right or left as the environment information of the intersection IS. The number of lanes referred to herein may be the number of lanes EL1 in the traveling direction TD1, that is, the number of lanes on one side when there are the lanes EL1 in the traveling direction TD1 of the subject vehicle Am and lanes in the opposite direction.

Here, an example of a processing method by the automated driving ECU 50b in the third embodiment will be described with reference to a flowchart of FIG. 13. S311 is similar to S111. After the process of S311, the process proceeds to S312.

In S312, the environment recognition section 62 determines whether the number of lanes of the road after a right or left turn is equal to or larger than a preset threshold value Tn1. For example, Tn1 may be 3. In a case of Yes, the process proceeds to S314. In a case of No, the process proceeds to S313.

In S313, the vehicle posture setting section 76 determines whether the number of lanes of the road after a right or left turn is equal to or larger than a preset threshold value Tn2. Here, it is assumed that the threshold value Tn2 is a value smaller than Tn1. For example, Tn2 may be 2. In a case of Yes, the process proceeds to S315. In a case of No, the process proceeds to S316.

S314 to 316 are similar to S114 to 116. After each process of S314 to 316, the process proceeds to S317. S317 is similar to S217. The series of processes terminates at S317.

According to the third embodiment described above, in a case where the number of lanes is equal to or larger than the preset threshold value after the subject vehicle Am turns right or left, the angle β of the steering wheel SW is set so that the steering wheel SW faces in the traveling direction TD1 after turning right or left with respect to the orientation of the vehicle body CB of the subject vehicle Am. In a case of a large intersection IS connected to a road having a plurality of lanes, it is highly probable that forming the angle β does not obstruct the traffic flow. Therefore, it is possible to promote the smooth traffic flow at the intersection IS by smoothly turning right or left with the angle β.

### Fourth Embodiment

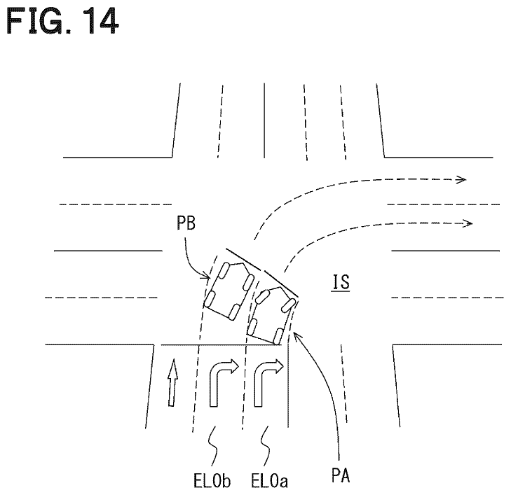

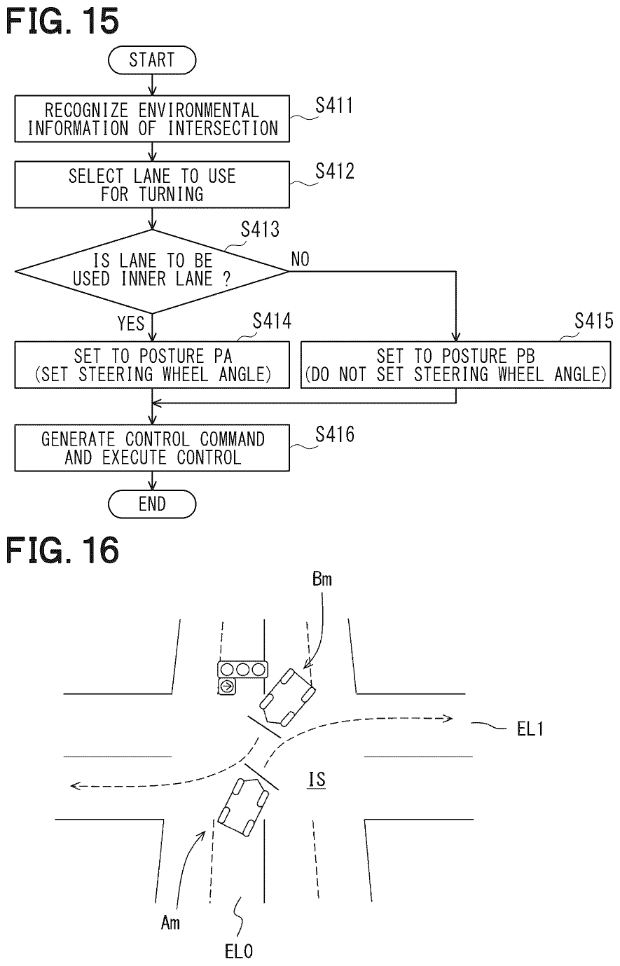

As illustrated in FIGS. 14 and 15, the fourth embodiment is a modification of the first embodiment. The fourth embodiment will be described focusing on differences from the first embodiment.

In the fourth embodiment, as illustrated in FIG. 14, the vehicle posture setting section 76 sets the vehicle posture at the temporary stop at the intersection IS where there is a plurality of lanes for the subject vehicle Am to proceed in the traveling direction TD1 after turning right or left. The plurality of lanes referred to herein may be two right-turn dedicated lanes EL0a and EL0b as illustrated in FIG. 13. One of the plurality of lanes may be a right turn dedicated lane, and one may be a combination lane of a straight lane and a right turn lane.

In the plurality of lanes, there are the inner lane EL0a on the inner side of the turn in the right or left turn and the outer lane EL0b on the outer side of the turn. In such a scene, for example, an even in which a vehicle using the inner lane EL0a and a vehicle using the outer lane EL0b come into contact when turning right or left at the same time should be avoided. Therefore, the vehicle posture setting section 76 sets a vehicle posture that allows the subject vehicle Am to make a smaller turn in the inner lane EL0a. The vehicle posture setting section 76 sets a vehicle posture so that the subject vehicle Am makes a larger turn in the outer lane EL0b. That is, the vehicle posture setting section 76 increases the angle β of the steering wheel SW as the lane used by the subject vehicle Am is further inward.

Here, an example of a processing method by the automated driving ECU 50b in the fourth embodiment will be described with reference to a flowchart of FIG. 15. Here, as illustrated in FIG. 13, it is assumed that there are two lanes of the inner lane EL0a and the outer lane EL0b. S411 is similar to S111. After the process of S411, the process proceeds to S412.

In S412, the action determination section 63 alternatively selects a lane to be used for a right or left turn in generating a traveling track scheduled for the subject vehicle Am. After the process of S412, the process proceeds to S413.

In S413, the vehicle posture setting section 76 determines whether the lane used for turning right or left is the inner lane EL0a. In a case of Yes, the process proceeds to S414. In a case of No, the process proceeds to S415.

S414 is similar to S114. After the process of S414, the process proceeds to S416. S415 is similar to S115. After the process of S415, the process proceeds to S416. S416 is similar to S217. The series of processes terminates at S416.

According to the fourth embodiment described above, at the intersection IS where the plurality of lanes EL0a and EL0b for the subject vehicle Am to proceed in the traveling direction TD1 after turning right or left is present, the setting of the angle β of the steering wheel SW differs depending on which lane of the plurality of lanes EL0a and EL0b is used. Using the setting optimized for each of the lanes EL0a and EL0b, the possibility of coming into contact with another vehicle at the intersection IS can be reduced.

### Fifth Embodiment

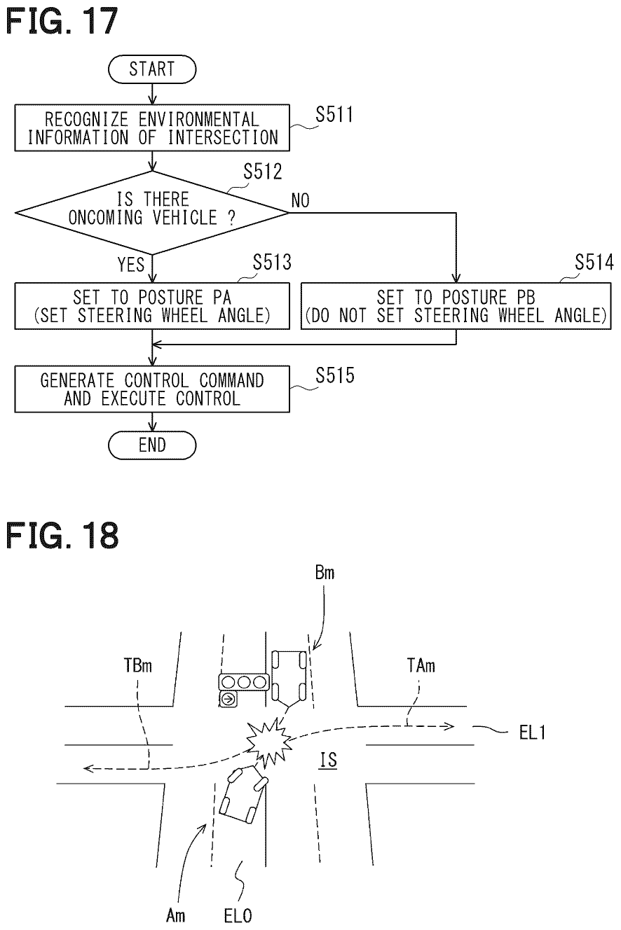

As illustrated in FIGS. 16 and 17, the fifth embodiment is a modification of the first embodiment. The fifth embodiment will be described focusing on differences from the first embodiment.

In the fifth embodiment, the vehicle posture setting section 76 sets the vehicle posture at the temporary stop according to the presence or absence of an oncoming vehicle Bm as another vehicle as the environment information of the intersection IS. As illustrated in FIG. 16, the oncoming vehicle Bm referred to herein is an oncoming vehicle that is about to turn right or left at the intersection IS. In a case where the subject vehicle Am is about to turn right, for example, the oncoming vehicle Bm is a vehicle that enters the intersection IS so as to face the subject vehicle Am and is about to turn right.

Here, an example of a processing method by the automated driving ECU 50b in the fifth embodiment will be described with reference to a flowchart of FIG. 17. S511 is similar to S111. After the process of S511, the process proceeds to S512.

In S512, the vehicle posture setting section 76 determines whether the above-described oncoming vehicle Bm is present. In a case of Yes, the process proceeds to S513. In a case of No, the process proceeds to S514.

S513 is similar to S114. After the process of S513, the process proceeds to S515. S514 is similar to S115. After the process of S514, the process proceeds to S515. S515 is similar to S217. The series of processes terminates at S515.

According to the fifth embodiment described above, in a case where the oncoming vehicle Bm is present, the angle β of the steering wheel SW is set so that the steering wheel SW faces in the traveling direction TD1 after turning right or left with respect to the orientation of the vehicle body CB of the subject vehicle Am. By forming the angle β, the subject vehicle Am can turn from immediately after restarting, and a track that makes a smaller turn can be used. Therefore, the possibility of coming into contact with the oncoming vehicle Bm can be reduced.

### Sixth Embodiment

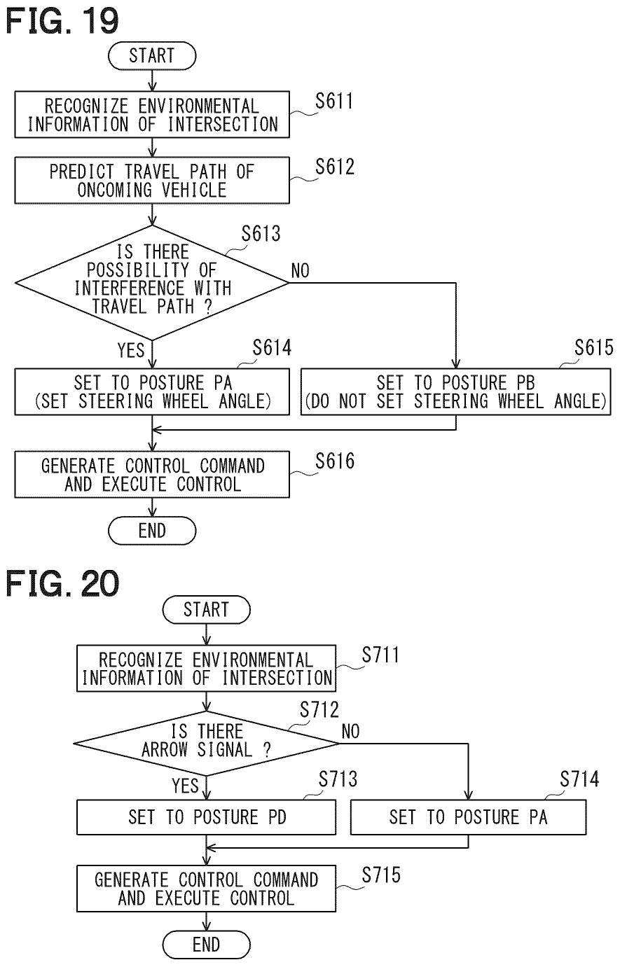

As illustrated in FIGS. 18 and 19, the sixth embodiment is a modification of the fifth embodiment. The sixth embodiment will be described focusing on differences from the fifth embodiment.

In the sixth embodiment, the action determination section 63 assumes the oncoming vehicle Bm that is about to turn right or left at the intersection IS, and further assumes a traveling track TBm predicted for the oncoming vehicle Bm (see FIG. 18). This prediction may be performed only in a case where an oncoming vehicle Bm actually is present. This prediction may be performed on the assumption that the oncoming vehicle Bm appears even in a case where the oncoming vehicle Bm is not actually present.

The vehicle posture setting section 76 determines whether there is a possibility that the traveling track TAm scheduled for the subject vehicle Am interferes with the traveling track TBm predicted by the oncoming vehicle Bm. The vehicle posture setting section 76 sets the vehicle posture in the temporary stop based on this determination.

Here, an example of a processing method by the automated driving ECU 50b in the sixth embodiment will be described with reference to a flowchart of FIG. 19. S611 is similar to S111. After the process of S611, the process proceeds to S612.

In S612, the action determination section 63 predicts the traveling track TBm of the oncoming vehicle Bm. After the process of S612, the process proceeds to S613.

In S613, the vehicle posture setting section 76 determines whether there is a possibility that the traveling track TAm scheduled for the subject vehicle Am interferes with the traveling track TBm. In a case of Yes, the process proceeds to S614. In a case of No, the process proceeds to S615.

S614 is similar to S114. After the process of S614, the process proceeds to S616. S615 is similar to S115. After the process of S614, the process proceeds to S616. S616 is similar to S217. The series of processes terminates at S616.

In S614, the posture PC (see FIG. 7) may be set instead of the posture PA. In S615, the posture PD may be set instead of the posture PB.

According to the sixth embodiment described above, in a case where there is a possibility that the traveling track TAm interferes with the traveling track TBm, the angle β of the steering wheel SW is set so that the steering wheel SW faces in the traveling direction TD1 after turning right or left with respect to the orientation of the vehicle body CB of the subject vehicle Am. By forming the angle β, the subject vehicle Am can turn from immediately after restarting, and the tack can be corrected to a smaller turning track. Therefore, the possibility of coming into contact with another vehicle at the intersection IS can be reduced.

### Seventh Embodiment

As illustrated in FIG. 20, the seventh embodiment is a modification of the first embodiment. The seventh embodiment will be described focusing on differences from the first embodiment.

In the seventh embodiment, the vehicle posture setting section 76 sets the vehicle posture in the temporary stop based on the information about the traffic signal at the intersection IS. Specifically, the information as to whether the arrow signal ATS related to the right or left turn of the subject vehicle Am is included in the traffic signal CTS at the intersection IS is used.

Here, an example of a processing method by the automated driving ECU 50b in the seventh embodiment will be described with reference to a flowchart of FIG. 20. S711 is similar to S111. After the process of S711, the process proceeds to S712.

In S712, the vehicle posture setting section 76 determines whether the traffic signal CTS includes the arrow signal ATS related to the right or left turn of the subject vehicle Am. In a case of Yes, the process proceeds to S713. In a case of No, the process proceeds to S714.

In S713, the vehicle posture setting section 76 sets the vehicle posture at the temporary stop at the intersection IS to the posture PD (see FIG. 8). That is, the orientation of the vehicle body CB is set along the lane EL0 on which the subject vehicle Am travels before turning right or left. After the process of S713, the process proceeds to S715.

In S714, the vehicle posture setting section 76 sets the vehicle posture at the temporary stop at the intersection IS to the posture PA (see FIG. 5). That is, the orientation of the vehicle body CB is set to be inclined toward the traveling direction TD1 after the right or left turn with respect to the lane EL0 on which the subject vehicle Am travels before the right or left turn. After the process of S714, the process proceeds to S715.

S715 is similar to S217. The series of processes terminates at S715.

In S713, the posture PC may be set instead of the posture PD. In S615, the posture PB may be set instead of the posture PA.

According to the seventh embodiment described above, in a case where the traffic signal CTS includes the arrow signal ATS related to the right or left turn of the subject vehicle Am, the orientation of the vehicle body CB at the temporary stop is set along the lane EL0 on which the subject vehicle Am travels before the right or left turn. In a case of turning right or left in accordance with the arrow signal ATS, it is less necessary to quickly turn right or left at a signal switching timing or the like, and thus it is possible to turn right or left with a margin even in such a direction.

### Eighth Embodiment

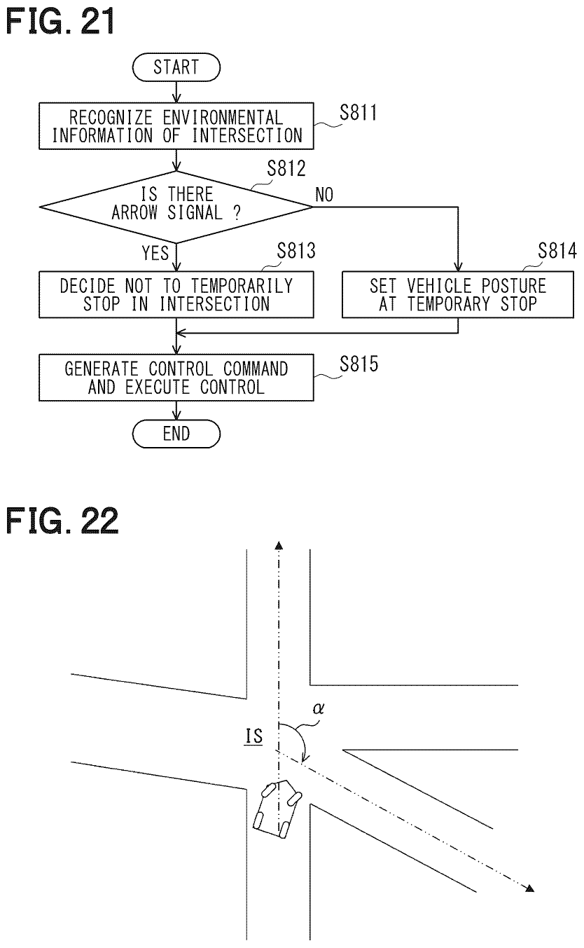

As illustrated in FIG. 21, the eighth embodiment is a modification of the seventh embodiment. The eighth embodiment will be described focusing on differences from the seventh embodiment.

In the eighth embodiment, the vehicle posture setting section 76 decides whether to temporarily stop in the intersection IS according to whether the arrow signal ATS related to the right or left turn of the subject vehicle Am is included in the traffic signal CTS of the intersection IS.

Here, an example of a processing method by the automated driving ECU 50b in the eighth embodiment will be described with reference to a flowchart of FIGS. 21. S811 to 812 are similar to S711 to 712. In a case of Yes in S712, the process proceeds to S813. In a case of No, the process proceeds to S814.

In S813, the vehicle posture setting section 76 decides not to temporarily stop in the intersection IS. In other words, since it is not necessary to set the vehicle posture itself, the vehicle posture setting section 76 omits the setting processing of the vehicle posture. After the process of S813, the process proceeds to S815.

In S814, the vehicle posture setting section 76 decides to stop temporarily in the intersection IS, and sets the vehicle posture in the temporary stop. The vehicle posture here may be set to any of the postures PA to PE. The setting of the vehicle posture may be performed based on environment information or the like. That is, the processing of another embodiment such as the first to sixth embodiment can be used. After the process of S814, the process proceeds to S815.

S815 is similar to S217. The series of processes terminates at S815.

According to the eighth embodiment described above, in a case where the traffic signal CTS includes the arrow signal ATS related to the right or left turn of the subject vehicle Am, the temporary stop in the intersection IS associated with the right or left turn is omitted. Since the time during which the subject vehicle Am stays in the intersection IS can be shortened by the temporary stop omission, the possibility of coming into contact with another vehicle at the intersection IS can be reduced.

### Ninth Embodiment

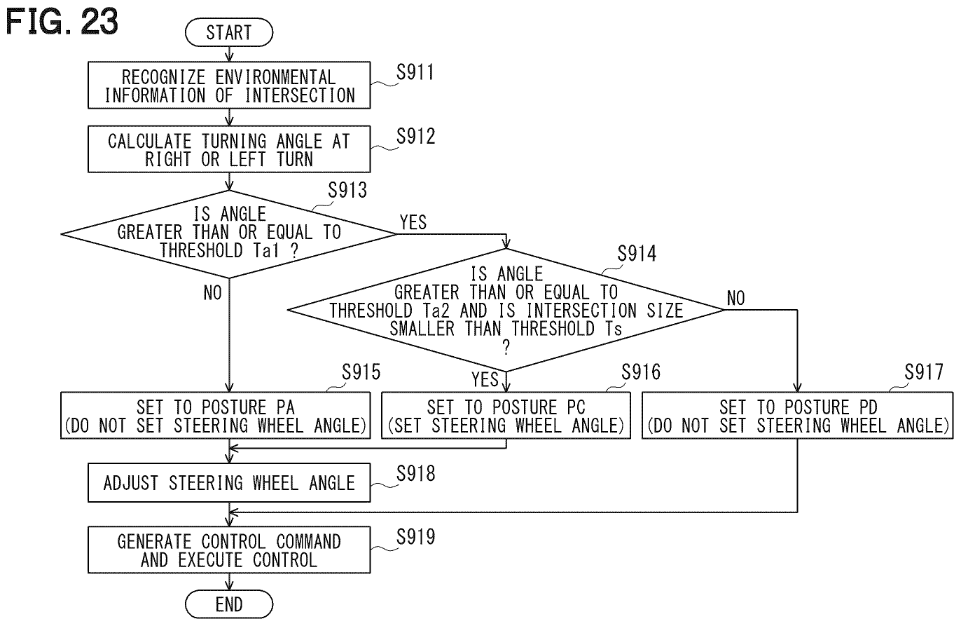

As illustrated in FIGS. 22 and 23, the ninth embodiment is a modification of the first embodiment. The ninth embodiment will be described focusing on differences from the first embodiment.

In the ninth embodiment, the vehicle posture setting section 76 sets the vehicle posture at the temporary stop according to the shape of the intersection IS as the environment information of the intersection IS. Specifically, the vehicle posture setting section 76 calculates an angle at which the subject vehicle Am turns right or left, that is, the right or left turn angle γ based on an orientation of a road connected to the intersection IS. The vehicle posture setting section 76 sets the vehicle posture at the temporary stop according to the angle γ. For example, in a case where the angle γ exceeds 90° in a five-way intersection or the like as illustrated in FIG. 22, the vehicle posture setting section 76 may perform setting so that the angle β of the steering wheel SW faces in the traveling direction TD1 after turning right with respect to the vehicle body CB.

In addition, the vehicle posture setting section 76 adjusts the angle β to such an angle that the rotation amount of the steering operation section of the subject vehicle Am is less than one rotation until the right or left turn is completed after the restart of the subject vehicle Am from the temporary stop. The angle β is set so as to gradually increase as the right or left turn angle γ increases.

Here, an example of a processing method by the automated driving ECU 50b in the ninth embodiment will be described with reference to a flowchart of FIG. 23. S911 is similar to S111. After the process of S911, the process proceeds to S912.

In S912, the vehicle posture setting section 76 calculates the right or left turn angle γ. After the process of S912, the process proceeds to S913.

In S913, the vehicle posture setting section 76 determines whether the angle γ is equal to or larger than a preset threshold value Ta1. In a case of Yes, the process proceeds to S915. In a case of No, the process proceeds to S914.

In S914, the vehicle posture setting section 76 determines whether the angle γ is equal to or larger than a preset threshold value Ta2 and the size of the intersection IS is smaller than a preset threshold value Ts. Here, it is assumed that the threshold value Ta2 is smaller than the threshold value Ta1. In a case of Yes, the process proceeds to S916. In a case of No, the process proceeds to S917.

In S915, the vehicle posture setting section 76 sets the vehicle posture at the temporary stop at the intersection IS to the posture PA (see FIG. 5). After the process of S915, the process proceeds to S918.

In S916, the vehicle posture setting section 76 sets the vehicle posture at the temporary stop at the intersection IS to the posture PC (see FIG. 7). After the process of S916, the process proceeds to S918.

In S917, the vehicle posture setting section 76 sets the vehicle posture at the temporary stop at the intersection IS to the posture PD (see FIG. 8). After the process of S917, the process proceeds to S919.

In S918, the vehicle posture setting section 76 adjusts the angle β of the steering wheel SW within the range of the vehicle posture set in S915 or S916. Specifically, the vehicle posture setting section 76 adjusts the angle β so that the rotation amount of the steering operation section is less than one rotation until the right or left turn is completed after the subject vehicle Am restarts from the temporary stop. Here, in a case where the posture PA is set, the inclination angle α of the vehicle body CB may be adjusted together with the angle β. After the process of S918, the process proceeds to S919.

S919 is similar to S217. The series of processes terminates at S919.

According to the ninth embodiment described above, in a case where the right or left turn angle γ is equal to or larger than the predetermined threshold value, the angle β of the steering wheel SW is set so that the steering wheel SW faces in the traveling direction TD1 after the right or left turn with respect to the orientation of the vehicle body CB of the subject vehicle Am. By forming the angle β, the subject vehicle Am can turn from immediately after restarting, so that it is possible to smoothly turn right or left with a large angle γ. The angle β is set so that the rotation amount of the steering operation section of the subject vehicle Am is less than one rotation until the right or left turn is completed after the subject vehicle Am restarts from the temporary stop. Since the rotation of the steering operation section can be suppressed, it is possible to reduce the uneasiness of the driver due to the turning when turning right or left.

### Tenth Embodiment

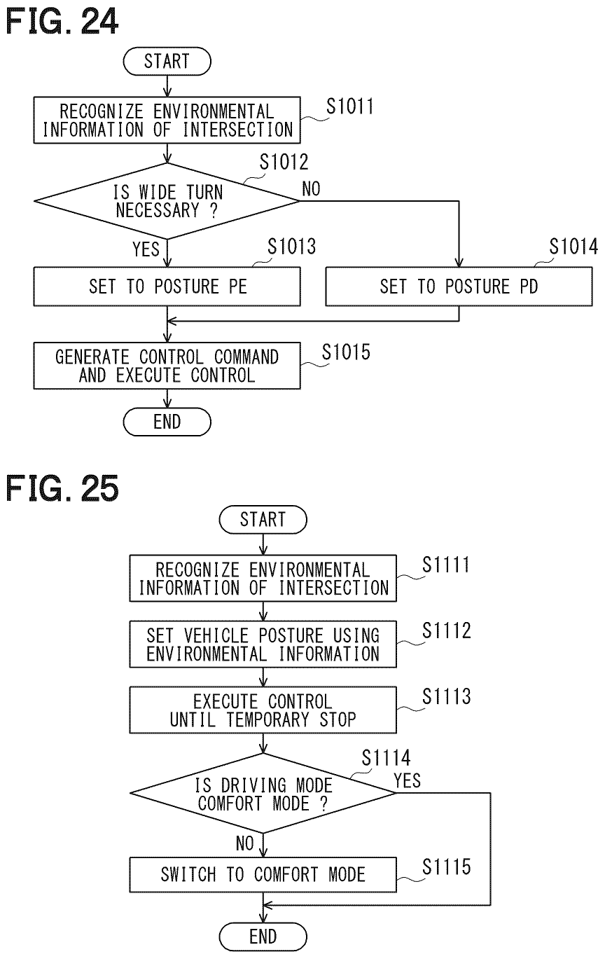

As illustrated in FIG. 24, the tenth embodiment is a modification of the first embodiment. The tenth embodiment will be described focusing on differences from the first embodiment.

In the tenth embodiment, the subject vehicle Am is a large vehicle. The large vehicle referred to herein is, for example, a bus, a truck, a trailer, or the like. A bus, a truck, and a trailer correspond to a vehicle type. Furthermore, the type of vehicle may include a small passenger vehicle, a normal passenger vehicle, and the like. Based on such a type, the vehicle posture setting section 76 can select the posture PE (see FIG. 9) as the vehicle posture.

In a case of a large vehicle, the inner wheel difference in a case where turning right or left is large. For this reason, when a large vehicle tries to make a small turn, there is a possibility that an object such as another vehicle, a building, or the like present inside at the time of turning is caught. In such a case, the subject vehicle Am can avoid catching by once executing steering in a direction opposite to the traveling direction TD1 after turning right or left and then executing steering in the traveling direction to make a large turn. The posture PE is suitable in a case where the subject vehicle Am makes a large turn.

Here, an example of a processing method by the automated driving ECU 50b in the tenth embodiment will be described with reference to a flowchart of FIG. 24. S1011 is similar to S111. After the process of S1011, the process proceeds to S1012.

In S1012, the vehicle posture setting section 76 determines whether it is necessary to make a large turn when turning right or left. This determination may be made based on, for example, the size of the intersection IS. In a case of Yes, the process proceeds to S1013. In a case of No, the process proceeds to S1014.

In S1013, the vehicle posture setting section 76 sets the vehicle posture at the temporary stop at the intersection IS to the posture PE. That is, the orientation of the vehicle body CB is set so that the vehicle body CB faces in a direction opposite the traveling direction TD1 after turning right or left with respect to the lane EL0 on which the subject vehicle Am travels before turning right or left. After the process of S1013, the process proceeds to S1015.

In S1014, the vehicle posture setting section 76 sets the vehicle posture at the temporary stop at the intersection IS to the posture PD. That is, the orientation of the vehicle body CB is set along the lane EL0 on which the subject vehicle Am travels before turning right or left. After the process of S1014, the process proceeds to S1015.

S1015 is similar to S217. The series of processes terminates at S1015.

According to the tenth embodiment described above, based on the type of the subject vehicle Am, the orientation of the vehicle body CB at the temporary stop is set so that the vehicle body CB of the subject vehicle Am faces in a direction opposite the traveling direction TD1 after the right or left turn with respect to the lane EL0 on which the subject vehicle Am travels before the right or left turn. As a result, even when the type is a large vehicle, the occurrence of a catching contact can be suppressed by making the subject vehicle Am make a large turn.

### Eleventh Embodiment

As illustrated in FIG. 25, the eleventh embodiment is a modification of the first embodiment. The eleventh embodiment will be described focusing on differences from the first embodiment.

In the tenth embodiment, the control switching section 75 switches the traveling mode in addition to the switching of the automation level and the like. For example, the traveling mode includes an eco-mode and a comfort mode. The traveling mode can be switched by the driver's intention when the driver operates the operation device 26. On the other hand, the automated driving system 50 can switch the traveling mode according to a predetermined condition.

The comfort mode is a mode for realizing comfortable traveling, and is a mode capable of smoothly starting again from a temporary stop. For example, in the comfort mode, the constraints of the engine speed, the acceleration, and the like as the constraints on the traveling performance are released. Further, an electric power steering function (a power assist function in steering) may be in an operation state. Therefore, even in the autonomous driving control, traveling that maximizes the performance of the subject vehicle Am can be executed.

The eco-mode is a mode in which energy cost such as fuel consumption and electricity cost is emphasized. The constraints of the engine speed, the acceleration, and the like are set. The upper limit of the engine speed is restricted to, for example, 1000 rpm. In addition, the electric power steering function may be in a non-operation state.

When the subject vehicle Am temporarily stops in the intersection IS in the autonomous driving control, the control switching section 75 checks the current traveling mode, and switches to the comfort mode before restarting in a case where the traveling mode is the eco-mode. By doing so, restart in the intersection IS can be smoothly performed. Even when the driving-mode switch from the system to the driver occurs suddenly during the temporary stop, for example, the driver can quickly restart and turn right or left.

Here, an example of a processing method by the automated driving ECU 50b in the eleventh embodiment will be described with reference to a flowchart of FIG. 25. S1111 is similar to S111. After the process of S1111, the process proceeds to S1112. In S1112, the vehicle posture setting section 76 sets the vehicle posture using the environment information. In the first embodiment, S1112 corresponds to the process of S112 to 116. After the process of S1112, the process proceeds to S1113. S1113 is similar to S217. After the process of S1113, the process proceeds to S1114.

In S1114, the control switching section 75 determines whether the traveling mode is the comfort mode. In a case of Yes, the series of processes terminates, and the subject vehicle Am is restarted at the time of restarting is possible. In a case of No, the process proceeds to S1115.

In S1115, the control switching section 75 switches the traveling mode to the comfort mode. The series of processes terminates at S1115, and the subject vehicle Am restarts when restarting is possible.

According to the eleventh embodiment described above, the traveling mode of the vehicle is switched to the mode in which the vehicle is allowed to smoothly start at the time of temporary stop. Therefore, since the time during which the subject vehicle Am stays in the intersection IS can be shortened, the possibility of coming into contact with another vehicle at the intersection IS can be reduced.

### Twelfth Embodiment

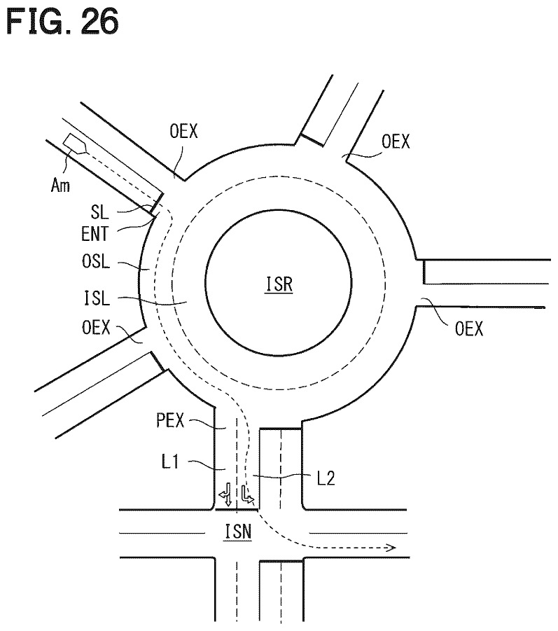

As illustrated in FIGS. 26 to 28, the twelfth embodiment is a modification of the first embodiment. The twelfth embodiment will be described focusing on differences from the first embodiment.

In the twelfth embodiment, the vehicle posture setting section 76 determines whether the intersection IS is the roundabout ISR based on the environment information, and sets a posture of the subject vehicle Am suitable for the roundabout ISR. For example, as illustrated in FIG. 26, it is conceivable that a route is set in which the subject vehicle Am passes through the roundabout ISR and then passes through a normal intersection (hereinafter, the next intersection) ISN where the planar intersection occurs at one point.

The roundabout ISR has a shape in which a plurality of linear other roads is radially connected to an annular road. The roundabout ISR may have one lane or a plurality of lanes on an annular road. In a case where a plurality of lanes is provided as illustrated in FIG. 23, the roundabout ISR has the outer lane OSL and the inner lane ISL in parallel with each other. The outer lane OSL is an annular lane connected to other roads via an entrance ENT and exits PEX and OEX. The inner lane ISL is an annular lane disposed radially inside the outer lane OSL. Normally, the lane change is possible between the outer lane OSL and the inner lane ISL over the entire circumference.

The vehicle posture setting section 76 sets the angle β of the steering wheel SW in a case where the subject vehicle Am temporarily stops accompanying the entry to the roundabout ISR according to the scale of the roundabout ISR. For example, the vehicle posture setting section 76 sets the angle β so that the steering wheel SW faces in a traveling direction after turning right or left with respect to the orientation of the vehicle body CB of the subject vehicle Am as the scale of the roundabout ISR is smaller. The scale of the roundabout ISR may be represented by, for example, a numerical value indicating the radius of the outermost periphery of the roundabout ISR. In this case, the angle β may be calculated by a function of a continuous numerical value indicating a scale. The angle β has a negative correlation with, for example, a numerical value indicating a radius, and may be inversely proportional to, for example the numerical value. On the other hand, the scale of the roundabout ISR may be expressed by the number of lanes in the roundabout. In this case, the angle β is calculated from a discrete numerical value indicating the scale.

The scale of the roundabout ISR may be classified into a large-scale roundabout and a small-scale roundabout depending on a condition combining a radius, the number of lanes, and the like. In this case, the vehicle posture setting section 76 may be configured to substantially change the angle β by switching the postures PC and PD according to the scale of the roundabout ISR. Instead of the postures PC and PD, the postures PA and PB may be switched. Here, the vehicle posture setting section 76 may set the orientation of the vehicle body CB so as to be substantially perpendicular to the stop line SL present at the time of entering the roundabout ISR.

Alternatively, the vehicle posture setting section 76 may set the orientation of the steering wheel SW, that is, the angle β so as to be substantially perpendicular to the stop line SL present at the time of entering the roundabout ISR regardless of the scale with respect to the roundabout as described above.

Now, it is conceivable that the road connecting the roundabout ISR and the next intersection ISN is a plurality of lanes one way. For example, as illustrated in FIG. 26, there is a case where the lanes from the roundabout ISR to the next intersection ISN are two lanes L1 and L2.

In a case where the traveling direction scheduled for the next intersection ISN is determined, it is preferable to enter a dedicated lane in the traveling direction among the plurality of lanes L1 and L2 along with the exit from the roundabout ISR. Therefore, the vehicle posture setting section 76 sets the angle β at the time of exiting from the roundabout ISR to an angle suitable for entering the dedicated lane from the traveling lane (for example, the outer lane OSL).

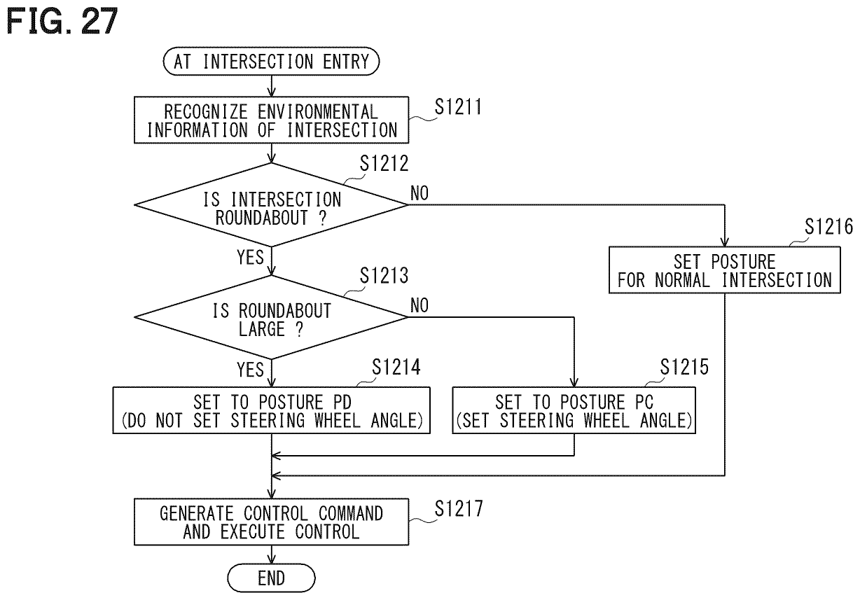

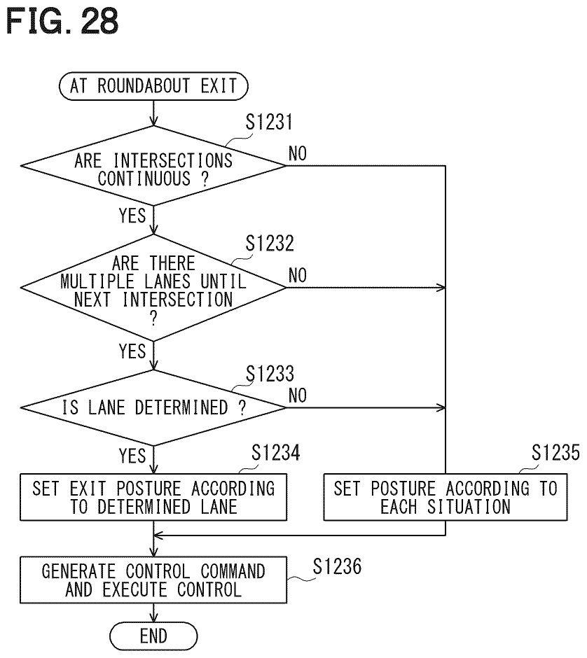

Here, an example of a processing method by the automated driving ECU 50b in the twelfth embodiment will be described with reference to flowcharts of FIGS. 27 and 28. The process in FIG. 27 is executed before the subject vehicle Am enters the intersection IS. S1211 is similar to S111. After the process of S1211, the process proceeds to S1212.

In S1212, the vehicle posture setting section 76 determines whether the intersection IS is the roundabout ISR. In a case of Yes, the process proceeds to S1213. In a case of No, the process proceeds to S1216.

In S1213, the vehicle posture setting section 76 determines whether the size of the roundabout ISR is large. In a case of Yes, the process proceeds to S1214. In a case of No, the process proceeds to S1215.

In S1214 in a case of the large-scale roundabout, the vehicle posture setting section 76 sets a posture of the vehicle in a case where the vehicle temporarily stops as the roundabout ISR enters to the posture PD. That is, the posture is a posture in which the steering wheel SW is along with the vehicle body CB of the subject vehicle Am, and the angle β is substantially zero. After the process of S1214, the process proceeds to S1217.

In S1215 in a case of the small-scale roundabout, the vehicle posture setting section 76 sets a posture of the vehicle in the posture PC in a case where the vehicle temporarily stops as the roundabout ISR enters. That is, the posture is a posture in which the steering wheel SW faces the traveling direction more with respect to the vehicle body CB of the subject vehicle Am. After the process of S1215, the process proceeds to S1217.

In S1216 in a case where the intersection IS is not a roundabout, the vehicle posture setting section 76 executes posture setting for a normal intersection. For example, the process of S112 to 116 may be executed. After the process of S1216, the process proceeds to S1217.

S1217 is similar to S217. The series of processes terminates at S1217, and the subject vehicle Am proceeds to the operation of entering the actual intersection IS.

The process in FIG. 27 is executed before the subject vehicle Am exits from the roundabout ISR. The process may be executed in advance before the subject vehicle Am enters the roundabout ISR. In S1231, the vehicle posture setting section 76 determines whether intersection continuation information is present. That is, after exiting from the roundabout ISR, it is determined whether the next intersection ISN is present. In a case of Yes, the process proceeds to S1232. In a case of No, the process proceeds to S1235.

In S1232, the vehicle posture setting section 76 determines whether there is a plurality of lanes L1 and L2 in the traveling direction of the subject vehicle Am on the road connecting the roundabout ISR and the next intersection ISN. In a case of Yes, the process proceeds to S1233. In a case of No, the process proceeds to S1235.

In S1233, the vehicle posture setting section 76 determines whether a lane through which the subject vehicle Am passes has been determined among the plurality of lanes L1 and L2. In a case of Yes, the process proceeds to S1234. In a case of No, the process proceeds to S1235.

In S1234, the vehicle posture setting section 76 sets a posture at the time of exiting from the roundabout ISR according to the position and the extension direction of the determined lane. This posture includes the angle β of the steering wheel SW. The series of processes terminates at S1234.

On the other hand, in S1235, the vehicle posture setting section 76 sets an appropriate posture according to each situation. The series of processes terminates at S1235.

According to the twelfth embodiment described above, in a case where the intersection IS is the roundabout ISR, the angle β of the steering wheel SW in a case where the subject vehicle Am temporarily stops as the subject vehicle Am enters the roundabout ISR is set according to the scale of the roundabout ISR. Since it is possible to execute an appropriate entry operation of the subject vehicle Am according to the scale, it is possible to promote smoothing of the traffic flow of the roundabout ISR.

According to the twelfth embodiment, the angle β of the steering wheel SW is set so that the steering wheel SW faces in a traveling direction after turning right or left with respect to the orientation of the vehicle body CB of the subject vehicle Am as the scale of the roundabout ISR is smaller. As a result, merging into a lane in the roundabout ISR having a small scale and a small curvature is facilitated.

In addition, according to the twelfth embodiment, a case where the intersection IS is a roundabout ISR, and a road connecting the roundabout ISR and a next intersection ISN has a plurality of lanes L1 and L2 will be considered. In this case, the angle β of the steering wheel SW at the time of exiting from the roundabout ISR is set according to the lane corresponding to the traveling direction scheduled for the next intersection ISN among the plurality of lanes L1 and L2. The traveling of the subject vehicle Am from the roundabout ISR to the next intersection ISN is appropriate, and the smooth traffic flow can be promoted.

### Thirteenth Embodiment

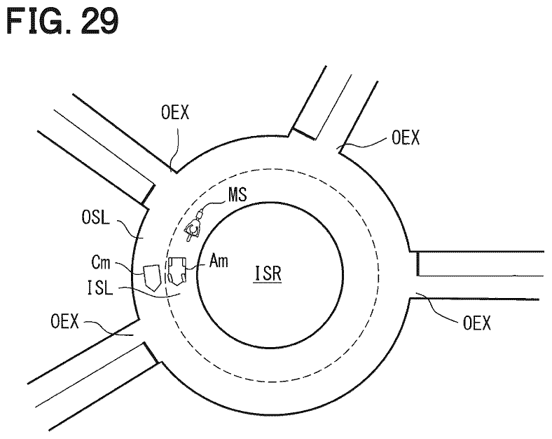

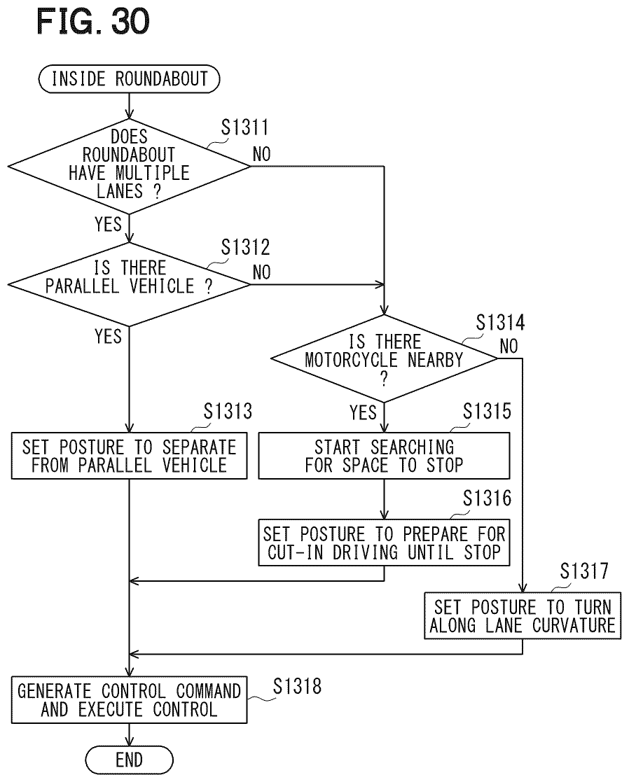

As illustrated in FIGS. 29 and 30, the thirteenth embodiment is a modification of the twelfth embodiment. The thirteenth embodiment will be described focusing on differences from the twelfth embodiment.

In the thirteenth embodiment, the vehicle posture setting section 76 sets the vehicle posture of the subject vehicle Am in the roundabout ISR in addition to the processing in the twelfth embodiment. As illustrated in FIG. 29, the vehicle posture setting section 76 can set the vehicle posture according to the presence of a moving object traveling in the same roundabout ISR.

For example, consider a case where the roundabout ISR has a plurality of lanes OSL and ISL, the subject vehicle Am is traveling in any one of the lanes, and a parallelly traveling vehicle Cm is present in a lane adjacent to the traveling lane of the subject vehicle Am. In this case, the vehicle posture setting section 76 adjusts the angle β of the steering wheel SW so as to be away from the parallelly traveling vehicle Cm.

That is, in a case where the parallelly traveling vehicle Cm is traveling in the radially outer lane than the subject vehicle Am as illustrated in FIG. 29, the angle of the steering wheel SW is set so that the front portion faces the radially inward, compared with a case of turning along the curvature of the traveling lane of the subject vehicle Am. On the other hand, in a case where the parallelly traveling vehicle Cm is traveling in the radially inner lane relative to the subject vehicle Am, the angle of the steering wheel SW is set so that the front portion faces the radially outward, compared with a case of turning along the curvature of the traveling lane of the subject vehicle Am. The angle may be set within a range in which the subject vehicle Am does not deviate from the current traveling lane.

In addition, the vehicle posture setting section 76 may change the angle β of the steering wheel SW so as to being away from the parallelly traveling vehicle Cm according to the size of the parallelly traveling vehicle Cm. For example, the angle may be set so that the larger the size of the parallelly traveling vehicle Cm, the more easily the subject vehicle is immediately away from the parallelly traveling vehicle Cm. That is, in a case of the large parallelly traveling vehicle Cm in the situation of FIG. 29, the angle is set so that the front portion faces radially outward, compared with a case of turning along the curvature of the traveling lane of the subject vehicle Am, and the angle difference from the case of turning along the curvature is made larger than that in a case of the small parallelly traveling vehicle Cm.

In addition, in a case where the motorcycle MS is present in the vicinity of the subject vehicle Am, the control execution section 64 may search for a space in which the subject vehicle Am can safely stop in the roundabout ISR and execute control of stopping the subject vehicle Am in the space. By this control, until the subject vehicle Am is stopped, the vehicle posture setting section 76 sets the angle β of the steering wheel SW in preparation for the cut-in driving of the motorcycle MS to the subject vehicle Am. Here, the case where the motorcycle MS is present in the vicinity of the subject vehicle Am may be a case where the motorcycle MS is traveling behind the subject vehicle Am so as to follow the subject vehicle Am. At this time, the motorcycle MS may travel in the same lane as the subject vehicle Am or may travel in an adjacent lane.

That is, the vehicle posture setting section 76 estimates and compares the probability that the motorcycle MS will cut in radially inward of the subject vehicle Am and the probability that the motorcycle MS will cut in radially outward based on the environment information. In a case where the probability of cutting in radially inward is larger than the probability of cutting in the radially outward, the angle of the steering wheel SW is set so that the front portion faces radially outward, compared with a case of turning along the curvature of the traveling lane of the subject vehicle Am. This makes it possible to reduce in advance the possibility of contact between the subject vehicle Am and the motorcycle MS.

Here, an example of a processing method by the automated driving ECU 50b in the thirteenth embodiment will be described with reference to a flowchart of FIG. 30. The process in FIG. 30 is executed while the subject vehicle Am is traveling in the roundabout ISR. In S1311, the vehicle posture setting section 76 determines whether the roundabout ISR has a plurality of lanes. In a case of Yes, the process proceeds to S1312. In a case of No, the process proceeds to S1314.

In S1312, the vehicle posture setting section 76 determines whether there is a parallelly traveling vehicle Cm traveling in parallel with the subject vehicle Am. In a case of Yes, the process proceeds to S1313. In a case of No, the process proceeds to S1314. In S1313, the vehicle posture setting section 76 sets a posture so as to be away from the parallelly traveling vehicle Cm. After the process of S1313, the process proceeds to S1318.

In S1314, the vehicle posture setting section 76 determines whether the motorcycle MS is present in the vicinity of the subject vehicle Am. In a case of Yes, the process proceeds to S1315. In a case of No, the process proceeds to S1317.

In S1315, the control execution section 64 starts searching for a space where the subject vehicle Am can safely stop in the roundabout ISR. In S1316 after the process of S1316, the vehicle posture setting section 76 sets a posture in preparation for the cut-in driving of the motorcycle MS until the subject vehicle Am stops in the searched space. After the process of S1315, the process proceeds to S1318.

In S1317, the vehicle posture setting section 76 sets, as the normal posture, a posture for turning along the curvature of the traveling lane of the subject vehicle Am. After the process of S1317, the process proceeds to S1318. S1318 is similar to S1236. The series of processes terminates at S1318.

According to the thirteenth embodiment described above, in a case where the intersection IS is the roundabout ISR having the plurality of lanes OSL and ISL, the subject vehicle Am travels in any of the plurality of lanes, and the parallelly traveling vehicle Cm is present in a lane adjacent to the lane, the angle β of the steering wheel SW is adjusted so as so as to be away from the parallelly traveling vehicle Cm. Thus, the possibility of coming into contact with the parallelly traveling vehicle Cm can be reduced.

In addition, according to the thirteenth embodiment, the angle β of the steering wheel SW is set so that the larger the size of the parallelly traveling vehicle Cm, the more easily the subject vehicle is immediately away from the parallelly traveling vehicle Cm. Therefore, the possibility of coming into coming into contact with the large parallelly traveling vehicle Cm can be reduced.

Further, according to the thirteenth embodiment, in a case where the intersection IS is the roundabout ISR, the subject vehicle Am travels in the lane in the roundabout ISR, and the motorcycle MS is present in the vicinity of the subject vehicle Am, the subject vehicle Am is stopped in a space where the subject vehicle Am is allowed to stop. Therefore, it is easy to avoid occurrence of a catching contact or the like with the motorcycle MS in the roundabout ISR.

According to the thirteenth embodiment, the angle β of the steering wheel SW in preparation for the cut-in driving of the motorcycle MS to the subject vehicle Am is set until the subject vehicle Am is stopped in the control described above. Therefore, even in a case where the motorcycle MS performs the cut-in driving, the possibility of contact can be reduced.

### Fourteenth Embodiment

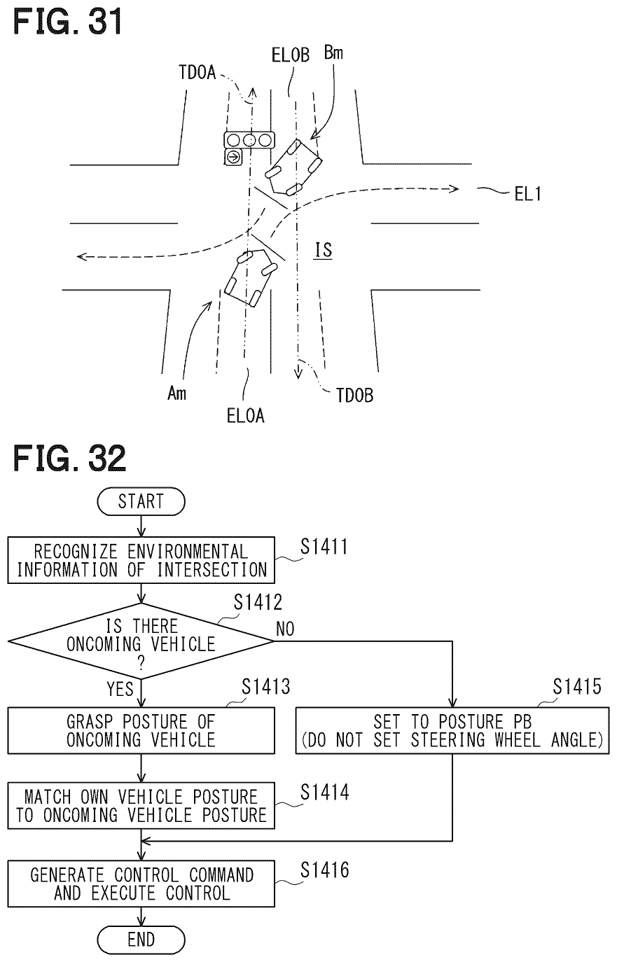

As illustrated in FIGS. 31 and 32, the fourteenth embodiment is a modification of the fifth embodiment. The fourteenth embodiment will be described focusing on differences from the fifth embodiment.

The fifteenth embodiment is particularly effective in a case where a traveling direction TD0X in the subject lane EL0A on which the subject vehicle Am travels before turning right and a traveling direction TD0Y in the opposite lane EL0B on which the oncoming vehicle Bm travels before turning right are substantially opposite directions (different by approximately 180 degrees), and the right or left turn angle γ at the intersection IS between the subject vehicle Am and the oncoming vehicle Bm is substantially equal.

In the fifth embodiment, the angle of the steering wheel differs depending on the presence or absence of the oncoming vehicle Bm, but in the fourteenth embodiment, the vehicle posture setting section 76 acquires information indicating the posture of the oncoming vehicle Bm as environment information. The another vehicle grasping section 72 recognizes the posture of the oncoming vehicle Bm by the surroundings monitoring sensor 30 and generates information indicating the posture in order to provide the information to the vehicle posture setting section 76.

The information indicating the posture includes the orientation of the vehicle body CB and the angle β of the steering wheel when the oncoming vehicle Bm temporarily stops at the intersection IS. The orientation of the vehicle body CB may be represented by the angle α with respect to the direction TD0Y, and the angle of the steering wheels may be represented by an angle based on the orientation of the vehicle body CB.

The vehicle posture setting section 76 adjusts the posture of the subject vehicle Am to the posture of the oncoming vehicle Bm. That is, by imitating the recognized posture of the oncoming vehicle Bm, the posture of the subject vehicle Am is a posture similar to the posture of the oncoming vehicle Bm. More specifically, the vehicle posture setting section 76 applies the orientation of the vehicle body CB of the oncoming vehicle Bm and the angle β of the steering wheels to the posture of the subject vehicle Am after replacing the reference for representing the orientation of the vehicle body CB of the oncoming vehicle Bm and the angle β of the steering wheels from the direction TD0Y to the direction TD0X. At this time, if the error range is plus or minus 10 degrees with respect to the orientation of the vehicle body CB of the oncoming vehicle Bm and the angle β of the steering wheels, it can be said that the posture of the subject vehicle Am is adjusted to the posture of the oncoming vehicle Bm.

Here, an example of a processing method by the automated driving ECU 50b in the fourteenth embodiment will be described with reference to a flowchart of FIG. 32. S1411 and 1412 are similar to S511, 512. In a case of Yes in S1412, the process proceeds to S1413. In a case of No, the process proceeds to S1415.

In S1413, the vehicle posture setting section 76 grasps the posture of the oncoming vehicle Bm based on the environment information. In S1414 after the process of S1413, the vehicle posture setting section 76 adjusts the posture of the subject vehicle Am to the posture of the oncoming vehicle Bm. After the process of S1414, the process proceeds to S1416.

S1415 is similar to S514. After the process of S1415, the process proceeds to S1416. S1416 is similar to S515. The series of processes terminates at S1416.

According to the fourteenth embodiment described above, the environment information includes information indicating the presence or absence and the posture of the oncoming vehicle Bm that is about to turn right or left at the intersection IS. In a case where the oncoming vehicle Bm is present, the posture of the subject vehicle Am is set according to a posture of the oncoming vehicle Bm. In this method, since an appropriate posture can be set by recognizing the oncoming vehicle Bm, it is possible to cope with a case where recognition of a road is poor, and the like.

### Fifteenth Embodiment

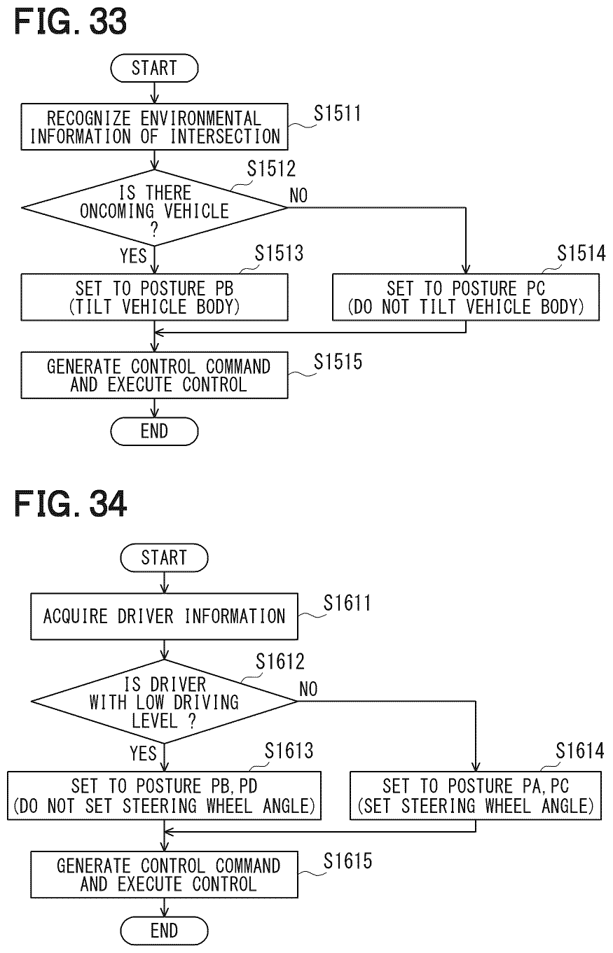

As illustrated in FIG. 33, the fifteenth embodiment is a modification of the fifth embodiment. The fifteenth embodiment will be described focusing on differences from the fifth embodiment. In the fifth embodiment, the angle of the steering wheel is made to be different depending on the presence or absence of the oncoming vehicle Bm, but in the fifteenth embodiment, the possibility of coming into contact with the oncoming vehicle Bm is reduced by making a difference in the orientation of the vehicle body CB.

Here, an example of a processing method by the automated driving ECU 50b in the fifth embodiment will be described with reference to a flowchart of FIG. 33. S1511 and 1512 are similar to S511, 512. In a case of Yes in S1512, the process proceeds to S1513. In a case of No, the process proceeds to S1514.

In S1513, the vehicle posture setting section 76 sets the vehicle posture at the temporary stop at the intersection IS to the posture PB (see FIG. 6). That is, the orientation of the vehicle body CB in the temporary stop is set to an inclined direction so as to face in the traveling direction after turning right with respect to the subject lane EL0 before entering the intersection IS. After the process of S1513, the process proceeds to S1515.

In S1514, the vehicle posture setting section 76 sets the vehicle posture at the temporary stop at the intersection IS to the posture PC (see FIG. 7). That is, the orientation of the vehicle body CB at the temporary stop is set to the direction along the subject lane EL0 before the vehicle enters the intersection IS. After the process of S1514, the process proceeds to S1515. S1515 is similar to S515. The series of processes terminates at S1515.

According to the fifteenth embodiment described above, the environment information includes information indicating the presence or absence of the oncoming vehicle Bm that is about to turn right or left at the intersection IS. The angle is set such that the angle of the orientation of the vehicle body CB of the subject vehicle Am with respect to the subject lane EL0 before entering the intersection IS is inclined to the traveling direction after the vehicle body CB turns right or left in a case where the oncoming vehicle Bm is present, compared with in the case where the oncoming vehicle Bm is not present. Therefore, it is easy to turn right or left at the intersection IS so as not to collide with the oncoming vehicle Bm.

### Sixteenth Embodiment

As illustrated in FIG. 34, the sixteenth embodiment is a modification of the first embodiment. The sixteenth embodiment will be described focusing on differences from the first embodiment.

In the sixteenth embodiment, the vehicle posture setting section 76 acquires information about the driver of the subject vehicle Am. The information about the driver may be registered in the HCU 100, for example, and acquired through the information linkage section 61. For example, the current driver can be identified by executing the personal authentication through the HCU 100 with the activation of the power switch of the subject vehicle Am.

The information about the driver may include the age, sex, and attribute of the driver. The attribute of the driver may include experience of manual driving, a driving score, and the like, and may further include personality and the like. The vehicle posture setting section 76 sets the angle β of the steering wheel SW at the temporary stop at the intersection IS according to the information about the driver.

For example, in a case where it is determined that the driver has a low driving level of the accelerator operation based on the above-described attribute, the angle β of the steering wheel SW at the temporary stop at the intersection IS is an angle along the orientation of the vehicle body of the subject vehicle Am. That is, when the emergency driving-mode switch occurs during the temporary stop of the intersection IS, in a case where the steering wheel SW is in the bent state, the driver having a low driving level of the accelerator operation is likely to make an error in the driving operation at the time of restarting, and thus, the angle setting for preventing this is performed. The driving level may be a driving score or a parameter calculated based on age, a driving score, and experience. A driver who is not accustomed to driving may be extracted instead of a driver whose driving level of the accelerator operation is low.

Here, an example of a processing method by the automated driving ECU 50b in the sixteenth embodiment will be described with reference to a flowchart of FIG. 34. In S1611, the vehicle posture setting section 76 acquires information about the driver. After the process of S1611, the process proceeds to S1612.

In S1612, the vehicle posture setting section 76 determines whether the driver of the subject vehicle Am is a driver who is not accustomed to driving. In a case of Yes, the process proceeds to S1613. In a case of No, the process proceeds to S1614.

In S1613, the vehicle posture setting section 76 sets the vehicle posture at the temporary stop at the intersection IS to the posture PB or the posture PD (see FIGS. 6 and 8). That is, the angle β is not set. After the process of S1613, the process proceeds to S1615.

In S1614, the vehicle posture setting section 76 sets the vehicle posture at the temporary stop at the intersection IS to the posture PA or the posture PC (see FIGS. 5 and 7). That is, the angle β is formed. After the process of S1614, the process proceeds to S1615. The process of S1615 is similar to that of S217. The series of processes terminates at S1615.

According to the sixteenth embodiment described above, the subject vehicle Am is configured to be able to execute a driving-mode switch to the driver of the subject vehicle Am in a case where the autonomous control of driving is not allowed to continue. The angle β of the steering wheel SW at the temporary stop at the intersection IS is set according to the acquired information about the driver. Therefore, it is possible to set an appropriate posture for the driver in preparation for a driving-mode switch in an emergency or the like.

According to the sixteenth embodiment, in a case where the driver is not accustomed to driving, the angle β of the steering wheel SW at the temporary stop at the intersection IS is an angle along the orientation of the vehicle body CB of the subject vehicle Am. In this way, in a case where driving-mode switch to the driver who is not accustomed to driving has occurred at the intersection IS, it is possible to reduce the possibility that the driver erroneously performs the driving operation immediately after the driving-mode switch.

### Seventeenth Embodiment

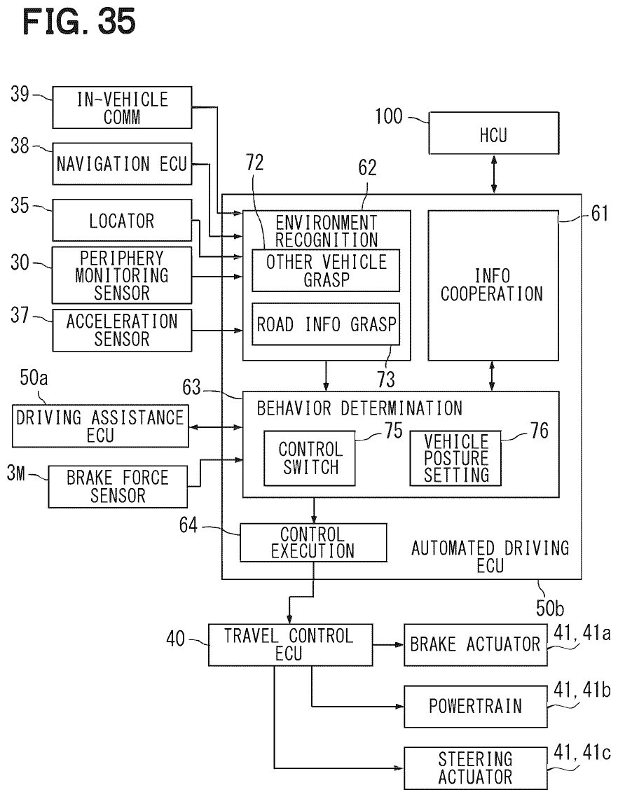

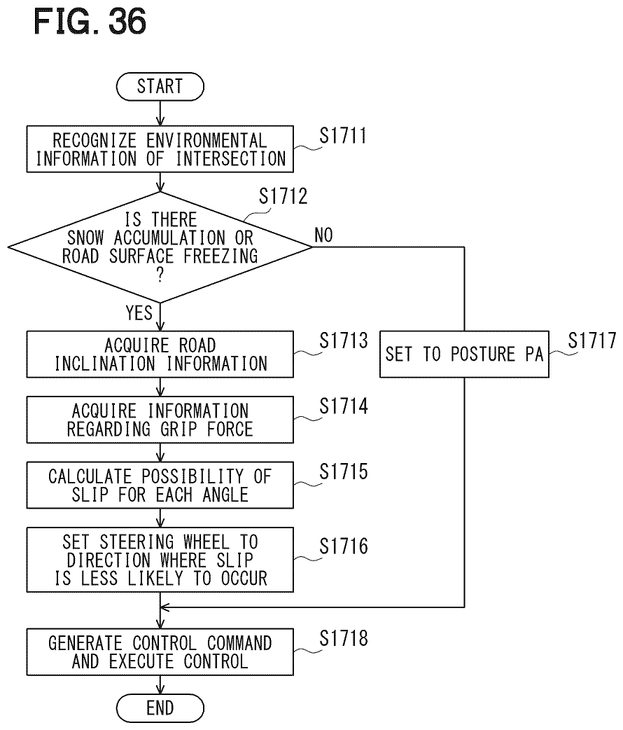

As illustrated in FIGS. 35 and 36, the seventeenth embodiment is a modification of the first embodiment. The seventeenth embodiment will be described focusing on differences from the first embodiment.

In the seventeenth embodiment, as illustrated in FIG. 35, the vehicle system 1 further includes a braking force measurement device 3M that measures the braking force of the subject vehicle Am. The braking force measurement device 3M monitors the operation state of the brake actuator 41a and the actual braking distance of the subject vehicle Am corresponding to the operation state. The braking force measurement device 3M measures the degree of effectiveness of the brake of the subject vehicle Am from the relationship between the operation state and the braking distance. The braking force measurement device 3M sequentially provides the measurement result to the action determination section 63 of the automated driving ECU 50b. As a result, the vehicle posture setting section 76 can grasp the normal degree of effectiveness of the brake in the subject vehicle Am. The braking force measurement device 3M may be referred to as a brake force sensor.

In addition, the road information grasping section 73 further grasps the condition and inclination of the road on which the subject vehicle Am is traveling. The vehicle posture setting section 76 sets the angle β of the steering wheel SW at the temporary stop of the intersection IS according to at least one of the condition or the inclination of the road.

Specifically, the vehicle posture setting section 76 determines whether a slip is likely to occur on the road, and sets the angle β of the steering wheel SW so that the slip is less likely to occur with respect to the inclination in a case where the slip is likely to occur. The situation in which slip is likely to occur is, for example, a situation in which snow accumulates on the road surface, a situation in which the road surface is frozen, and the like. For example, since the grip force of the steering wheel SW in the lateral direction tends to be large (skidding tends to be difficult) while the vehicle is stopped, the angle may be set so that the orientation of the steering wheel SW, is different from the direction in which the gradient of the road is maximum, and preferably, the direction is substantially perpendicular to the direction in which the gradient of the road is maximum. Of course, a direction in which slip is less likely to occur with respect to the inclination may be selected within a range in which a right and left turn can be smoothly performed.

In addition, the vehicle posture setting section 76 may decide the direction in which the slip is unlikely to occur using the information about the grip force of the steering wheel SW, for example, the measurement result by the braking force measurement device 3M. This may be executed regardless of whether the slip is likely to occur.

For example, the vehicle posture setting section 76 calculates and estimates the possibility of occurrence of slip for each angle of the steering wheel SW based on the information about the road condition and the grip force. The angular pitch of this calculation may be, for example, a 10 degree pitch or a 15 degree pitch. In addition, inclination information may be further used for this calculation. The vehicle posture setting section 76 sets the final angle β of the steering wheel SW to an angle at which the possibility of occurrence of slip is low (for example, the lowest) from the calculation result for each angle.

Here, an example of a processing method by the automated driving ECU 50b in the seventeenth embodiment will be described with reference to a flowchart of FIG. 36. S1711 is similar to S111. After the process of S1711, the process proceeds to S1712.

In S1712, the vehicle posture setting section 76 determines whether the road surface is in a snow accumulation state or a frozen state based on the environment information. In a case of Yes, the process proceeds to S1713. In a case of No, the process proceeds to S1717.

In S1713, the vehicle posture setting section 76 acquires road inclination information. In S1714 after the process of S1713, the vehicle posture setting section 76 acquires information about the grip force of the subject vehicle Am. After the process of S1714, the process proceeds to S1715.

In S1715, the vehicle posture setting section 76 calculates the possibility of occurrence of slip for each angle. In S1716 after the process of S1715, the angle β of the steering wheel SW is set in a direction in which the slip is less likely to occur based on the calculation result. After the process of S1716, the process proceeds to S1718.

On the other hand, in S1717 in a case where the road condition is good, the vehicle posture setting section 76 sets the angle to the standard posture PA (see FIG. 5). After the process of S1717, the process proceeds to S1718. S1718 is similar to S217. The series of processes terminates at S1718.

According to the seventeenth embodiment described above, the environment information includes information about the condition of the road. The angle β of the steering wheel SW at the temporary stop of the intersection IS is set according to the condition. Therefore, it is possible to suppress the occurrence of trouble caused by the condition of the road.

In addition, according to the seventeenth embodiment, the environment information further includes information about the inclination of the road. In a case where the condition includes a situation where slip is likely to occur on the road, the occurrence of slip can be suppressed by the angle of the steering wheel SW according to the inclination in which the angle β of the steering wheel SW is set so that the slip is less likely to occur with respect to the inclination.

In addition, according to the seventeenth embodiment, the possibility of occurrence of slip with respect to the temporary angle setting of the steering wheel SW is estimated based on the information about the condition of the road and the grip force of the steering wheel SW, and the final angle of the steering wheel SW is set based on the possibility. Therefore, occurrence of slip can be suppressed.

### OTHER EMBODIMENTS

Although a plurality of embodiments has been described above, the present disclosure is not to be construed as being limited to these embodiments, and can be applied to various embodiments and combinations without departing from the gist of the present disclosure.

As another embodiment, various conditions can be used as the determination condition for setting the vehicle posture. For example, the vehicle posture setting section 76 may set the vehicle posture based on a determination condition obtained by combining the shape of the intersection IS, the presence or absence of the oncoming vehicle Bm, information about the traffic signal CTS, and the like. Furthermore, the vehicle posture setting section 76 may set the vehicle posture by determination using a learned model configured by a neural network or the like.

As another embodiment, the vehicle control by the automated driving ECU 50b can be appropriately optimized according to the road traffic law, custom, and the like of each country and region. For example, in the first to eleventh embodiment, left-hand traffic is premised based on the road traffic law in Japan, but the vehicle control can be optimized on the premise that the vehicle travels on the right side.

As another embodiment, the setting of the vehicle posture at the temporary stop of the intersection IS may be applied by an application used for driving assistance at the automation level 2. For example, in an application that assists steering to turn right or left at the intersection IS on the premise that acceleration/deceleration is performed by the driver, the vehicle posture setting section 76 may set the vehicle posture along with the execution of the temporary stop operation by the driver.

As another embodiment, the intersection IS to be the setting target of the vehicle posture may be various intersections. For example, the vehicle posture setting section 76 may set the vehicle posture at a temporary stop at a complex intersection including a three-dimensional intersection, a roundabout, or the like.

As another embodiment, the vehicle on which the vehicle system 1 is mounted is not limited to a general private passenger car, but may be a vehicle for a rental car, a vehicle for a manned taxi, a vehicle for ride-sharing, or the like. Further, in the vehicle, the steering wheels SW may be rear wheels or all four wheels.

The control unit and its method described in the present disclosure may be implemented by a dedicated computer comprising a processor programmed to execute one or more functions embodied by a computer program. Alternatively, the device and its method described in the present disclosure may be implemented by dedicated hardware logic circuits. Furthermore, the device and its method described in the present disclosure may be implemented by one or more dedicated computers configured by a combination of a processor that executes a computer program and one or more hardware logic circuits. In addition, the computer program may be stored as instructions executable by a computer on a computer-readable, non-transitory, tangible recording medium.

What is claimed is:

1. A vehicle control device that autonomously controls driving of a subject vehicle, the vehicle control device comprising
at least one of (i) a circuit and (ii) a processor with a memory storing computer program code executable by the processor, the at least one of the circuit and the processor configured to cause the vehicle control device to implement:
an environment recognition section configured to recognize environment information at an intersection; and
a setting section configured to set, using the environment information, an angle of a steering wheel of the subject vehicle in a case where the subject vehicle temporarily stops while making a right or left turn at the intersection,
wherein
the environment information includes a size of the intersection, and
the setting section sets the angle of the steering wheel such that, when the size of the intersection is equal to or greater than a preset threshold value, the steering wheel is oriented toward a traveling direction after the right or left turn, relative to an orientation of a vehicle body of the subject vehicle, and
the setting section sets the angle of the steering wheel such that, when the size of the intersection is smaller than the preset threshold value, the steering wheel is oriented in alignment with the orientation of the vehicle body.

2. The vehicle control device according to claim 1, wherein
the at least one of the circuit and the processor is further configured to cause the vehicle control device to implement
a control execution section configured to control the subject vehicle from traveling to a temporary stop such that an operation of the temporary stop is completed with the steering wheel at the angle set by the setting section.

3. The vehicle control device according to claim 1, wherein
the setting section sets the orientation of the vehicle body at a temporary stop based on a type of the subject vehicle, such that the vehicle body faces a direction opposite to a traveling direction after the right or left turn with respect to a lane in which the subject vehicle travels before the right or left turn.

4. The vehicle control device according to claim 1, wherein
the at least one of the circuit and the processor is further configured to cause the vehicle control device to implement
a control switching section configured to switch a traveling mode of a vehicle to a mode in which the subject vehicle is allowed to smoothly start at a time of a temporary stop.

5. The vehicle control device according to claim 1, wherein
in a case where the intersection is a roundabout,
the setting section sets the angle of the steering wheel in a case where the subject vehicle temporarily stops upon entering the roundabout, according to a scale of the roundabout.

6. The vehicle control device according to claim 5, wherein
the setting section sets the angle of the steering wheel such that, as the scale of the roundabout decreases, the steering wheel is oriented toward a traveling direction after the right or left turn with respect to an orientation of the vehicle body of the subject vehicle.

7. The vehicle control device according to claim 5, wherein
in a case where a road connecting the roundabout and a next intersection has a plurality of lanes,
the setting section sets the angle of the steering wheel at a time of exiting the roundabout according to a lane corresponding to a traveling direction scheduled for the next intersection among the plurality of lanes.

8. The vehicle control device according to claim 1, wherein
in a case where the intersection is a roundabout having a plurality of lanes, the subject vehicle travels in any of the plurality of lanes, and a parallelly traveling vehicle is traveling in an adjacent lane,
the setting section adjusts the angle of the steering wheel so as to be away from the parallelly traveling vehicle.

9. The vehicle control device according to claim 8, wherein
the setting section sets the angle of the steering wheel such that the larger a size of the parallelly traveling vehicle, the more easily the subject vehicle is immediately away from the parallelly traveling vehicle.

10. The vehicle control device according to claim 1, wherein
the at least one of the circuit and the processor is further configured to cause the vehicle control device to implement
a control execution section configured to stop the subject vehicle in a space where the subject vehicle is allowed to stop in a case where the intersection is a roundabout, the subject vehicle travels in a lane within the roundabout, and a motorcycle is present near the subject vehicle.

11. The vehicle control device according to claim 10, wherein
the setting section sets the angle of the steering wheel in preparation for cut-in driving of the motorcycle to the subject vehicle until the subject vehicle is stopped.

12. The vehicle control device according to claim 1, wherein
the environment information includes information indicating presence or absence and a posture of an oncoming vehicle that is about to turn right or left at the intersection, and
the setting section sets a posture of the subject vehicle according to the posture of the oncoming vehicle in a case where the oncoming vehicle is present.

13. The vehicle control device according to claim 1, wherein
the environment information includes information indicating presence or absence of an oncoming vehicle that is about to turn right or left at the intersection, and
the setting section sets an angle such that an angle of an orientation of the vehicle body of the subject vehicle with respect to a subject lane before entering the intersection is inclined to a traveling direction after the vehicle body turns right or left in a case where the oncoming vehicle is present, compared with in a case where the oncoming vehicle is not present.

14. The vehicle control device according to claim 1, wherein
the subject vehicle is configured to execute a driving-mode switch to a driver of the subject vehicle in a case where autonomous control of driving is not allowed to continue, and
the setting section acquires information about the driver, and sets an angle of the steering wheel at a temporary stop at the intersection according to the information about the driver.

15. The vehicle control device according to claim 14, wherein
in a case where the driver is a driver whose driving level with respect to accelerator operation is low,
the setting section sets an angle of the steering wheel at a temporary stop at the intersection to an angle aligned with the orientation of the vehicle body of the subject vehicle.

16. The vehicle control device according to claim 1, wherein
the environment information includes information about a condition of a road, and
the setting section sets the angle of the steering wheel at a temporary stop of the intersection according to the condition.

17. The vehicle control device according to claim 16, wherein
the environment information further includes information about an inclination of a road, and
in a case where the condition includes a situation in which a slip is likely to occur on the road,
the setting section sets the angle of the steering wheel such that a slip is less likely to occur with respect to the inclination.

18. The vehicle control device according to claim 16, wherein
the setting section acquires information about a grip force of the steering wheel, estimates a possibility of occurrence of a slip with respect to a temporary angle setting of the steering wheel based on information about the condition and the grip force, and sets a final angle of the steering wheel based on the possibility.

19. A non-transitory computer readable storage medium storing a vehicle control program for autonomously controlling driving of a subject vehicle, the vehicle control program for causing
at least one processing section to execute:
recognizing environment information at an intersection; and
setting an angle of a steering wheel of the subject vehicle in a case where the subject vehicle temporarily stops along with a right or left turn at the intersection using the environment information,
wherein
the environment information includes a size of the intersection, and
the setting the angle of the steering wheel sets the angle of the steering wheel such that, when the size of the intersection is equal to or greater than a preset threshold value, the steering wheel is oriented toward a traveling direction after the right or left turn, relative to an orientation of a vehicle body of the subject vehicle, and
the setting the angle of the steering wheel sets the angle of the steering wheel such that, when the size of the intersection is smaller than the preset threshold value, the steering wheel is oriented in alignment with the orientation of the vehicle body.

20. A vehicle control method of autonomously controlling driving of a subject vehicle, the vehicle control method being executed by at least one processing section, the vehicle control method comprising:
recognizing environment information at an intersection; and
setting an angle of a steering wheel of the subject vehicle in a case where the subject vehicle temporarily stops along with a right or left turn at the intersection using the environment information,
wherein
the environment information includes a size of the intersection, and
the setting the angle of the steering wheel sets the angle of the steering wheel such that, when the size of the intersection is equal to or greater than a preset threshold value, the steering wheel is oriented toward a traveling direction after the right or left turn, relative to an orientation of a vehicle body of the subject vehicle, and
the setting the angle of the steering wheel sets the angle of the steering wheel such that, when the size of the intersection is smaller than the preset threshold value, the steering wheel is oriented in alignment with the orientation of the vehicle body.
